(19) United States
(12) Patent Application Publication
(10) Pub. No.: US 2023/0210177 A1
(43) Pub. Date: Jul. 6, 2023

(54) Aerosol Generating Device Element

(71) Applicant: JT International SA, Geneva (CH)

(72) Inventor: Claude Zominy, Copponex (FR)

(73) Assignee: JT International SA, Geneva (CH)

(21) Appl. No.: 17/927,560

(22) PCT Filed: May 26, 2021
(86) PCT No.: PCT/IB2021/054575

§ 371 Date: Nov. 23, 2022

(30) Foreign Application Priority Data
May 28, 2020 (EP) 20177121.9
May 28, 2020 (EP) 20177127.6

(51) Int. Cl. A24F 40/44; A24F 40/10; A24F 40/42; A24F 40/46; H05B 3/10

(52) U.S. Cl. CPC A24F 40/44; A24F 40/10; A24F 40/42; A24F 40/46; H05B 3/10; H05B 2203/021

(57) ABSTRACT

The present disclosure concerns a vaporizer element (1) for an aerosol generating device including a structure (3) defining a chamber (5) configured for removably receiving at least a portion of a consumable therein, the consumable being removable from the structure and containing at least one vaporizable material. The structure comprises at least one wick structure (7) for receiving the at least one vaporizable material, the at least one wick structure extending along at least an inner portion of the structure to define at least a portion of the chamber. The vaporizer element includes first and second heating means (37, 39) comprising a braided conductor heating element or a meshed structure, the wick structure extending fully or partially therebetween.

### FIELD OF THE INVENTION

The present disclosure relates to an element for an aerosol generating device and for producing an aerosol or vapor for inhalation by a user. The present disclosure relates more particularly to a vaporizer element or heating element for an aerosol generating device. The present disclosure also relates to an inhalation device including such an aerosol generating device vaporizer or heating element.

### BACKGROUND

US2019/0216129 discloses a cartridge containing a heater and a reservoir comprising a liquid to be vaporized by the heater. The reservoir includes a mesh holding the liquid.

US2017/0215479 discloses a heating element comprising a cavity having a nub for receiving a sticky wax, a bottom coil heater and heating wires embedded in walls of the heating element.

US2016/0324215 discloses an electrical heater comprising a polymeric substrate having an electrically resistive material printed in tracks thereon.

Such heating elements do not permit reception of a consumable or capsule containing a vapor or aerosol generating substance and release of the vapor or aerosol generating substance to the heating elements for efficient vaporization.

Consequently, the background art presents a number of deficiencies and problems and the present disclosure seeks to address these difficulties.

### SUMMARY

It is therefore one aspect of the present disclosure to provide a vaporizer element for an aerosol generating device. Preferably, the aerosol generating device vaporizer or heating element comprises a structure defining a chamber configured for removably receiving at least a portion of a consumable therein, the consumable being removable from the structure and containing at least one vaporizable material, and the structure comprises at least one wick structure for receiving the at least one vaporizable material, the at least one wick structure extending along at least an inner portion of the structure to define at least a portion of the chamber.

The aerosol generating device vaporizer or heating element comprises a first heating means and a second heating means, the at least one wick structure extending fully or partially between the first and second heating means. The first and/or second heating means comprise or consist of a braided conductor heating element or a meshed structure.

The vaporizer element of the present disclosure permits the reception of a consumable containing a vapor or aerosol generating substance or material as well the reception of the vapor or aerosol generating substance to be heated outside the consumable thus assuring a more efficient vaporization and aerosol generation.

According to another aspect of the present disclosure, the structure comprises a base and/or at least one wall extending to define the chamber, and the at least one wick structure extends along or defines at least a portion of the base and/or at least a portion of the at least one wall.

According to yet another aspect of the present disclosure, the at least one wick structure fully defines the at least one wall and/or the base.

According to another aspect of the present disclosure, the at least one wall extends outwards from a first extremity to define an opening at a second extremity for receiving the consumable.

According to yet another aspect of the present disclosure, the first extremity is configured to receive the at least one vaporizable material from the consumable.

According to yet another aspect of the present disclosure, the at least one wick structure extends along an inner surface of the at least one wall between the opening and the first extremity or between the opening and the base, or defines an inner surface of the at least one wall between the opening and the first extremity or between the opening and the base.

According to yet another aspect of the present disclosure, the at least one wick structure is in thermal contact with the first and/or second heating means.

According to yet another aspect of the present disclosure, the first and/or second heating means extends along at least an outer portion of the structure or at least an inner portion of the structure to define at least a portion of the chamber.

According to yet another aspect of the present disclosure, the first heating means is located in or on the base or defines the base, and the second heating means is located in or on the at least one wall or defines at least a portion of the at least one wall.

According to yet another aspect of the present disclosure, the at least one wick structure only extends between the first and second heating means.

According to yet another aspect of the present disclosure, the first heating means is located at the first extremity, and the second heating means is located between the opening and the first extremity, or at the second extremity of the at least one wall defining the opening.

According to yet another aspect of the present disclosure, the first heating means is located in or on the base or defines the base, and the second heating means is located in or on the at least one wall or defines at least a portion of the at least one wall.

According to yet another aspect of the present disclosure, the first and second heating means are located in or on the at least one wall or each define at least a portion of the at least one wall.

According to yet another aspect of the present disclosure, the first and/or second heating means comprise or consist of a braided wire heating element or a meshed structure configured to displace the at least one vaporizable material by capillary action.

According to yet another aspect of the present disclosure, the braided wire heating element or the meshed structure includes a plurality of open pores configured to receive the vaporizable material and to displace the vaporizable material by capillary action.

According to yet another aspect of the present disclosure, the at least one wall extends upwards and laterally outwards to define the opening for receiving the consumable.

According to yet another aspect of the present disclosure, the at least one wall extends upwards and laterally outwards to define a truncated and/or tapered chamber for receiving the consumable.

According to yet another aspect of the present disclosure, the structure delimits, at least partially, a conical, square or hexagonal shape; or defines a conical, square or hexagonal circumference.

According to yet another aspect of the present disclosure, the first and second heating means are configured to be individually controlled and located to define two separate heating zones so as to provide a temperature gradient or difference across the structure for selective evaporation of constituents of the at least one vaporizable material.

According to yet another aspect of the present disclosure, the vaporizer element further includes a consumable perforating mechanism or consumable opening mechanism configured to permit the release of the at least one vaporizable material from the consumable onto the structure, or the at least one wick structure or heating means.

According to yet another aspect of the present disclosure, the consumable perforating mechanism or consumable opening mechanism is configured to define an aperture in the consumable permitting capillary release of the at least one vaporizable material from the consumable to the structure, or the at least one mesh or heating means.

According to yet another aspect of the present disclosure, the consumable perforating mechanism or consumable opening mechanism is configured to permit the release of the at least one vaporizable material to the first extremity of the at least one wall or to the base and then upwards along the at least one wall by capillary displacement of the at least one vaporizable material.

According to yet another aspect of the present disclosure, the structure includes the first and second heating means, the first and second heating means being separately located on the structure and along at least one fluidic communication path of the at least one vaporizable material, and wherein the first heating means is configured to generate a first vaporization heating temperature and the second heating means is configured to generate a second vaporization heating temperature different to the first vaporization heating temperature.

According to yet another aspect of the present disclosure, the first and second heating means extend to each define at least a portion of at least one wall of the chamber.

According to yet another aspect of the present disclosure, each of the first and second heating means extend circumferentially to define portions of the chamber or of the at least one wall.

According to yet another aspect of the present disclosure, the first heating means is between the first and second extremities, and the second heating means is located between the first heating mean and the second extremity.

According to yet another aspect of the present disclosure, the first and second braided conductor heating elements or meshed structures define an intertwined or interlaced network for receiving the at least one vaporizable material.

According to yet another aspect of the present disclosure, the first braided conductor heating element and/or the second braided conductor heating element includes braided wire and a flexible substrate or blade to which the braided wire is attached, or includes braided wire and at least one clamp to which the braided wire is attached.

According to yet another aspect of the present disclosure, the structure defines a truncated and/ortapered chamber.

According to yet another aspect of the present disclosure, the structure delimits, at least partially, a conical, square or hexagonal shaped holder; or defines a conical, square or hexagonal circumference.

According to yet another aspect of the present disclosure, each of the first and second heating means (37, 39) separately extend to each define a portion of the chamber (5).

According to yet another aspect of the present disclosure, the at least one wick structure is located at or delimits the first extremity and/or the second extremity.

According to another aspect of the present disclosure, a consumable system is provided, the consumable system including the vaporizer element.

According to yet another aspect of the present disclosure, the consumable system further includes, in addition to the vaporizer element, at least one consumable containing at least one vaporizable material wherein the at least one consumable is a heater-less consumable or heating element-less consumable.

According to yet another aspect of the present disclosure, the opening defined by the at least one wall of the vaporizer element for receiving the consumable is wider that the at least one consumable to facilitate lateral evaporation of the at least one vaporizable material.

According to yet another aspect of the present disclosure, the at least one consumable includes a valve or membrane, and the consumable perforating mechanism or consumable opening mechanism comprises an actuator for activating the valve or piercing the membrane.

According to yet another aspect of the present disclosure, the at least one consumable delimits, at least partially, a conical, square or hexagonal shape; or defines a conical, square or hexagonal circumference.

According to another aspect of the present disclosure, an aerosol generating device is provided, the aerosol generating device including the vaporizer element and/or the consumable system.

According to yet another aspect of the present disclosure, the aerosol generating device includes a cavity receiving the vaporizer element, and a plurality of electrical contact arranged to contact or press against the first heating means and/or the second heating means permitting to provide current to the first and second heating means for heating the vaporizable material.

A further aspect of the present disclosure provides a heating assembly for an aerosol generating device element. Preferably, the heating assembly comprises a first heater or heating means, a second heater or heating means and a structure defining a holder configured to receive at least one vaporizable material. The structure includes the first and second heaters, and the first and second heaters are separately located on the structure and along at least one fluidic communication path of the at least one vaporizable material. The first heater is configured to generate a first vaporization heating temperature and the second heater is configured to generate a second vaporization heating temperature different to the first vaporization heating temperature.

The heating assembly of the present disclosure assures a more convenient manner for the inhalation device user to replenish the inhalation device with a vapor or aerosol generating substance.

According to an aspect of the present disclosure, the first and second heaters extend to each define at least a portion of at least one wall of the holder.

According to another aspect of the present disclosure, each of the first and second heaters extend circumferentially to define the portions of the holder or of the at least one wall.

According to another aspect of the present disclosure, the structure comprises a first extremity and a second extremity, and the first heater is between the first and second extremities, and the second heater is located between the first heater and the second extremity.

According to another aspect of the present disclosure, the first heater comprises or consists of a braided conductor heating element, and/or the second heater comprises or consists of a braided conductor heating element.

According to another aspect of the present disclosure, the first and second braided conductor heating elements define an intertwined or interlaced network for receiving the at least one vaporizable material.

According to another aspect of the present disclosure, the first braided conductor heating element and/or the second braided conductor heating element includes braided wire and a flexible substrate or blade to which the braided wire is attached, or includes braided wire and at least one clamp to which the braided wire is attached.

According to another aspect of the present disclosure, the structure defines a truncated and/or tapered holder.

According to another aspect of the present disclosure, the structure delimits, at least partially, a conical, square or hexagonal shaped holder; or defines a conical, square or hexagonal circumference.

According to another aspect of the present disclosure, the structure defines a holder configured for removably receiving at least a portion of a consumable configured to contain at least one vaporizable material, each of the first and second heaters separately extending to each define a portion of the holder.

According to another aspect of the present disclosure, the structure further comprises at least one wick structure for receiving the at least one vaporizable material, the at least one wick structure extending along at least an inner portion of the structure to define at least a portion of the holder.

According to another aspect of the present disclosure, the at least one wick structure extends fully or partially between the first and second heaters.

According to another aspect of the present disclosure, the at least one wick structure is located at or delimits the first extremity and/or the second extremity.

According to another aspect of the present invention, a consumable configured to contain at least one vaporizable material is provided. The consumable includes the heating assembly, or the structure consists of a capsule configured to contain the at least one vaporizable material, the capsule including the first and second braided conductor heating elements and each of the first and second braided conductor heating elements separately extending circumferentially around the capsule.

The heating assembly of the present disclosure assures the provision of a consumable that is relatively less complex to fabricate.

According to another aspect of the present invention, an aerosol generating device is provided, the aerosol generating device including a cavity receiving the heating asssembly, and a plurality of electrical contacts arranged to contact or press against the first heater and the second heater permitting to provide current to the first and second heaters for heating the at least one vaporizable material; or

including a chamber for receiving the consumable, and a plurality of electrical contacts arranged to contact or press against the first heater and the second heater of the consumable to provide current to the first and second heaters for heating the vaporizable material.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1A shows a schematic side view of an exemplary implementation of an aerosol generating device vaporizer element or aerosol generating device heating element according to the present disclosure receiving a consumable containing a vaporizable material, and FIG. 1B shows the consumable received therein.

FIG. 2 shows a schematic of another exemplary implementation of an aerosol generating device vaporizer element or heating element according to the present disclosure.

FIGS. 3 and 4 show schematic other exemplary implementations of an aerosol generating device vaporizer element or heating element according to the present disclosure.

FIG. 5 schematically shows an exemplary implementation of a portion of an aerosol generating device including an exemplary aerosol generating device vaporizer element or heating element according to present disclosure.

FIG. 6 schematically shows a section of an aerosol generating device including an aerosol generating device vaporizer element or heating element according to present disclosure and, received therein, a consumable containing a vaporizable material.

FIG. 7A shows a schematic side view of an exemplary implementation of an aerosol generating device vaporizer element or heating element according to the present disclosure, and FIG. 7B shows a schematic top view of the exemplary implementation of the aerosol generating device vaporizer element or heating element of FIG. 7A.

FIG. 8 depicts a schematic of another exemplary implementation of an aerosol generating device vaporizer element or heating element according to the present disclosure.

FIG. 9 shows a schematic of yet another exemplary implementation of an aerosol generating device vaporizer element or heating element according to the present disclosure.

FIGS. 10A and 10B show schematics of other exemplary implementations of an an aerosol generating device vaporizer element or heating element according to present disclosure.

FIG. 11A shows a schematic of a consumable being received in an exemplary an aerosol generating device vaporizer element or heating element according to present disclosure, and FIG. 11B shows the consumable received therein.

FIG. 12 schematically shows an exemplary implementation of a consumable according to present disclosure.

FIG. 13 schematically shows an exemplary implementation of a portion of an aerosol generating device including an exemplary aerosol generating device vaporizer element or heating element according to present disclosure.

FIG. 14 schematically shows a section of an aerosol generating device including a vaporizer element or heating element according to present disclosure and a consumable.

FIGS. 15 and 16 schematically show a section of an aerosol generating device and a consumable according to a further aspect of the present disclosure.

FIG. 17A schematically shows an exemplary mechanism for holding extremities of a braided conductor heating element and for defining an enclosure profile of a braided conductor heating element. FIG. 17B is a top view showing a defined enclosure profile. FIG. 17C shows a further exemplary mechanism in which a plurality of braided conductor heating elements is used to define an enclosure profile. FIG. 17D also shows a further exemplary manner in which a plurality of braided conductor heating elements is used to define an enclosure profile. FIG. 17E schematically shows another exemplary mechanism for holding and defining an enclosure profile of the braided conductor heating elements.

FIG. 18A schematically shows a blade attached to a braided conductor heating element and FIG. 18B schematically shows an enclosure profile defined using the blade included in the braided conductor heating element.

FIG. 19 schematically shows an alternative mechanism for defining an enclosure profile of a braided conductor heating element comprising a plug that is configured to be retained by press fit between extremities of the braided conductor heating element.

FIG. 20 schematically shows a braided conductor heating element of length l₁ and electrical connectors or contacts contacting the braided conductor heating element and separated by a distance d₁.

FIG. 21 schematically shows an exemplary configuration for providing an electrical current through portions of one or more braided conductor heating elements.

FIGS. 22A and 22B schematically show exemplary consumable perforating mechanisms or consumable opening mechanisms configured to permit the release of a vapor material from the consumable.

FIGS. 23A to 23C show exemplary braid patterns. FIG. 23A shows a Hercules braid or triple overlap braid, FIG. 23B shows a regular braid or double overlap braid and FIG. 23C shows a diamond braid or single overlap braid. FIG. 23D shows another example pattern defined by three braided elongated conductive elements. FIG. 23E schematically shows an exemplary non-regular or non-uniform profile of an elongated conductive element of a braid structure according to the present disclosure.

FIGS. 24A and 24B show portions of non-limiting exemplary patterns and profiles of a braided structure or network of the present disclosure.

FIGS. 25A to 25C show non-limiting exemplary mesh patterns. FIG. 25A shows a diamond pattern in which diamond-shaped openings are delimited. FIG. 25B shows a square pattern in which square-shaped openings are delimited. FIG. 25C shows a honeycomb pattern in which honeycomb-shaped openings are delimited.

FIG. 26A schematically shows a side view of an exemplary implementation of an aerosol generating device vaporizer element or aerosol generating device heating element according to the present disclosure, and FIG. 26B shows a top view of the aerosol generating device vaporizer element or heating element of FIG. 26A.

FIG. 27 schematically shows another exemplary implementation of an aerosol generating device vaporizer element or heating element according to the present disclosure.

FIG. 28 schematically shows another exemplary implementation of a portion of an aerosol generating device for receiving a consumable according to the present disclosure.

Herein, identical reference numerals are used, where possible, to designate identical elements that are common to the Figures. Also, the images are simplified for illustration purposes and may not be depicted to scale.

### DETAILED DESCRIPTION OF SEVERAL EMBODIMENTS

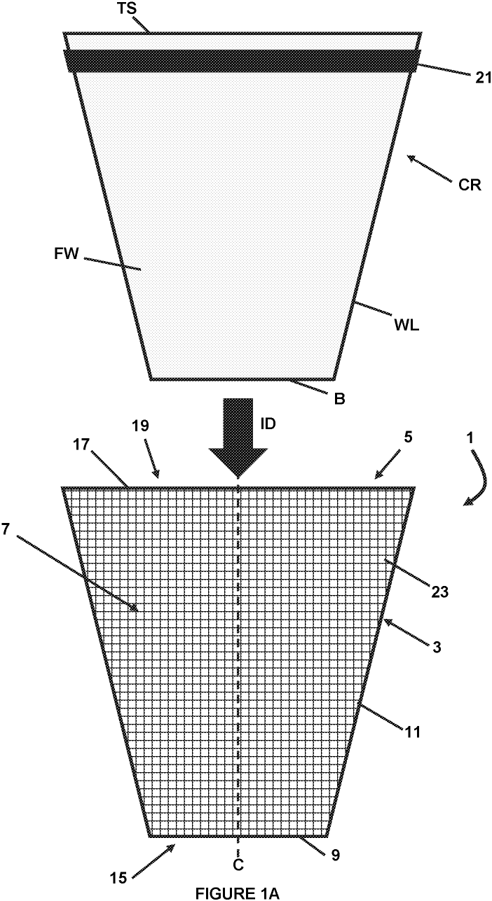

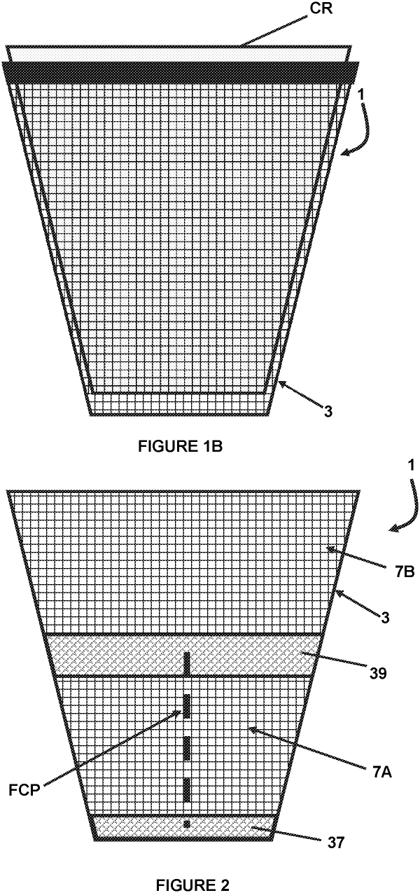

Exemplary embodiments of an aerosol generating device element 1 (or element for an aerosol generating device), or an aerosol generating device vaporizer element or heating element 1 according to the present disclosure are shown, for instance, in FIGS. 1 to 5 and FIGS. 8 to 10. The Figures depict exemplary schematic views of the aerosol generating device element with different components in a symbolic representation.

The vaporizer element or heating element 1 is, for example, to be used in or included in an aerosol generating device, an inhalation device or an electronic cigarette.

The vaporizer element 1 includes a structure or body 3 defining a chamber, cavity or holder 5 configured for removably receiving at least a portion of a consumable CR inside the structure 3 and the chamber 5.

The term consumable is used to designate a cartridge, capsule, pod or article configured to hold a vaporizable material.

The consumable CR contains at least one vaporizable material to be evaporated or vaporized.

The term vaporizable material is used to designate any material that is vaporizable at a temperature up to 400° C., preferably up to 350° C. The vaporizable material may, for example, comprise or consist of an aerosol generating liquid, gel, or wax or the like, or any combination of these.

The consumable CR is removable or fully removable from the structure 3.

The structure 3 can be, for example, flexible. The structure 3 defines, for example, a basket-like holder or a nacelle-like holder for receiving and temporarily holding a consumable CR therein.

The structure 3 may comprise or consist solely of at least one wick or wicking structure 7 or a plurality of wick or wicking structures 7 configured to receive and (temporarily) hold the at least one vaporizable material from the consumable CR.

The wick structure 7 extends along at least an inner portion IP of the structure 3 to define at least a portion of the chamber 5 or to fully define the chamber 5.

The structure 3 comprises a base 9 and/or at least one wall 11 extending to define the chamber 5. The wick structure 7 extends along or defines at least a portion of the base 9 and/or at least a portion of the at least one wall 11.

The wick structure 7 may extend along and fully define the base 9 and/or the at least one wall 11. The wick structure 7 may define a closed base 9.

A first wick structure 7A may, for example, define the base 9 and a second wick structure 7B may, for example, define the at least one wall 11. The first and second wick structures 7A, 7B may be attached together using one or more attachment mechanisms, such as for example, a looped wire attachment.

The wall 11 extends outwards from a first or lower extremity 15 and upwards to define an opening 17 for receiving the consumable CR at a second or upper extremity 19. The wall 11 extends outwards from a first or lower extremity 15 in a direction extending away from a center axis C (see, for example, FIG. 1A).

The wick structure 7 extends along at least an inner surface of the wall 11 between the opening 17 and the lower extremity 15, or between the opening 17 and the base 9. The wick structure 7 may define an inner surface of the wall 11 (or of each wall 11) between the opening 17 and the first extremity 15, or between the opening 17 and the base 9.

At least a portion or a plurality of portions of the inner surface defined by the wick structure 7 is configured or located to directly contact a portion of the consumable CR or to be directly facing a portion of the consumable CR.

The wick structure 7 may define an inner surface of the base 9.

The wick structure 7 may additionally define an outer surface of the wall 11 (or of each wall 11) between the opening 17 and the first extremity 15, or between the opening 17 and the base 9. The wick structure 7 may additionally define an outer surface of the base 9.

The first or lower extremity 15 or base 9 and/or the wall or walls 11 of the structure 3 are configured to receive the vaporizable substance from the consumable CR. The wick structure 7 of the structure 3 is configured to receive the vaporizable material from the consumable CR.

The wick structure 7 is positioned or configured to directly or indirectly receive the vaporizable material released from at least one aperture of the consumable CR. The wick structure 7 is positioned or configured to directly receive the vaporizable material released from at least one aperture of the consumable CR on an inner surface of the wall 11 and/or an inner surface of the base 9.

FIG. 1A shows a schematic side view of an exemplary implementation of a vaporizer element 1. The vaporizer element 1 is shown receiving a consumable CR containing a vaporizable material. FIG. 1B shows the consumable CR received inside the vaporizer heating element 1. The consumable CR may include, for example, a seal 21 configured to contact the wall 11 to temporarily retain the consumable CR in the structure 3.

The exemplary embodiment of FIGS. 1A and 1B show a vaporizer element 1 in which the wick orwicking structure 7 extends to fully define the base 9 and the wall 11.

The wick or wicking structure 7 is configured to receive and hold the least one vaporizable material.

The wick structure 7 is, for example, configured to displace the vaporizable material through the wick structure 7 by capillary action or by a capillary force. The wick structure 7 is configured to generate a capillary pressure to transport or displace the vaporizable material.

The capillary displacement of the vaporizable material is carried on the material in a liquid state. If not already provided by the consumable CR as a liquid, heat energy, for example, provided by a heater assures the transformation to a liquid state, for example, in the case where the consumable contains a vaporizable material consisting of or comprising wax.

The wick structure 7 may, for example, comprise or consist of a plurality of strands, yarns or filaments 23.

The plurality of strands, yarns or filaments 23 may, for example, be attached together to define at least one network, web or net of attached strands, yarns or filaments 23.

The one or the plurality of strands yarns or filaments 23 may extend to define a plurality of open pores or openings configured to displace the vaporizable material in the wick structure 7 by capillary action or by a capillary force. The open pores or openings may, for example, have an opening width or diameter of between 10 µm and 1000 µm, or between 10 µm and 500 µm.

The one or the plurality of strands 23 may, for example, be intertwined, interlaced or interwoven to define the plurality of pores.

The wick structure 7, for example, comprises or consists of an electrically non-conductive material or a low conductivity material. The strands 23, for example, comprise or consist of an electrically non-conductive material or a material that is of low conductivity. The strands 23 are, for example, non-metallic. The strands 23 may, for example, comprise or consist of Polyester or cotton.

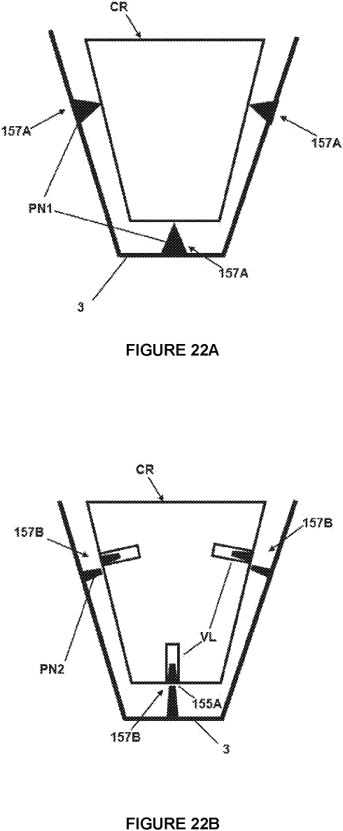

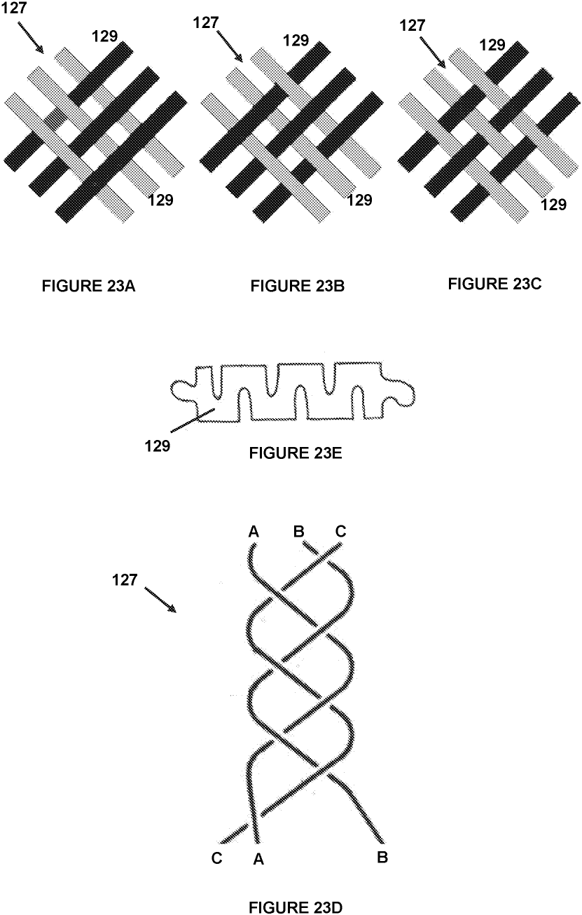

The wick structure 7 may, for example, define or comprise a braided structure, such as for example the braided structure described in detail herein and later in the present disclosure, examples of which are illustrated in FIGS. 23 and 24.

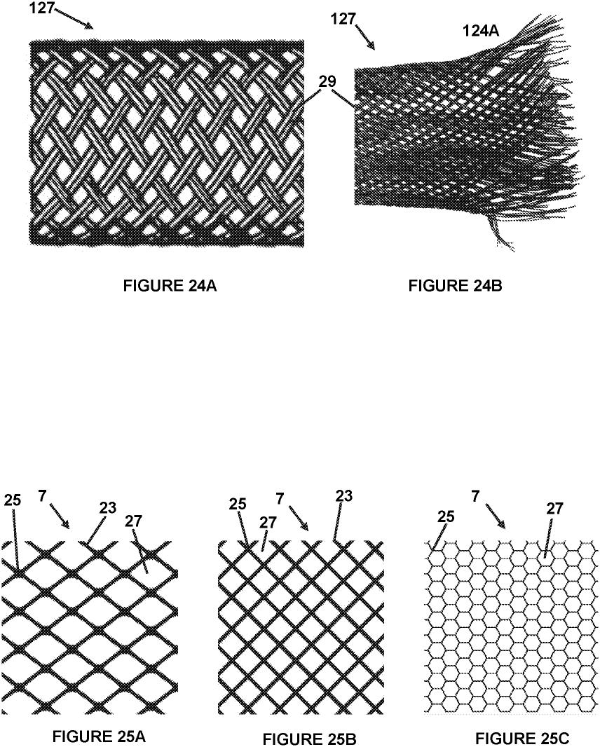

Alternatively or additionally, the wick structure 7 may, for example, comprise or consist of a mesh or meshed structure 7 comprising or consisting of a plurality of strands, yarns or filaments 23 that are attached together to define at least one network, web or net of attached strands, yarns or filaments. The meshed structure 7 may comprise a plurality of intersections 25 at which at least two strands, yarns or filaments intersect. The meshed structure 7 comprises a plurality of open spaces or apertures 27 between the attached strands, yarns or filaments 23. The strands, yarns or filaments 23 are attached together to define a plurality of open spaces or pores 27 between the attached strands, yarns or filaments 23, as for example seen in FIGS. 25A to 25C.

The open spaces or pores 27 may, for example, have an opening width or diameter of between 10 µm and 1000 µm, or between 10 µm and 500 µm.

The plurality of open spaces or apertures 27 defined between the strands, yarns or filaments 23 are, for example, configured to displace or transport the vaporizable material along the mesh 7 by capillary action or by wicking.

The plurality of strands, yarns or filaments 23 are, for example, intertwined or interwoven together. The attached strands, yarns or filaments 23 may, for example, be fused, looped, interwoven, knitted or knotted together at their intersections 25.

The strands, yarns or filaments 23 can, for example, be attached to be immobile to move with respect to each other, or immobile to slide over or with respect to each other at the intersection 25.

Alternatively, the mesh 7 may comprise a single continuous strand, yarn or filament 23 extending to define a structure comprising the plurality of openings or apertures 27.

The plurality of strands, yarns or filaments 23 can, for example, be attached together to define at least one pattern or a plurality of patterns. FIGS. 25A to 25C show non-limiting exemplary mesh patterns. FIG. 25A shows a diamond pattern in which diamond-shaped openings 27 are delimited, FIG. 25B shows a square pattern in which square-shaped openings 27 are delimited and FIG. 25C shows a honeycomb pattern in which honeycomb-shaped openings 27 are delimited.

The wick or meshed structure 7 may, for example, comprise or consist of a weaved structure or comprise or consist of interwoven strands, yarns, threads or filaments 23. The interwoven strands, yarns, threads or filaments 23 may, for example, be interwoven to define a plain weave pattern, a twill weave pattern, a satin weave pattern, a basket weave pattern, or a Gauze weaving pattern.

The strands, yarns or filaments 23 may, for example, comprise or consist of Polyester or cotton or a metal. The metal may comprise or consist of, for example, aluminum, copper, gold or steel, or a metallic alloy of any of aluminum, copper, gold or steel.

The wick structure 7 may be a freestanding structure or self-supporting. The wick or mesh structure 7 is, for example, non-attached or non-fixed onto an underlying or internal support or framework.

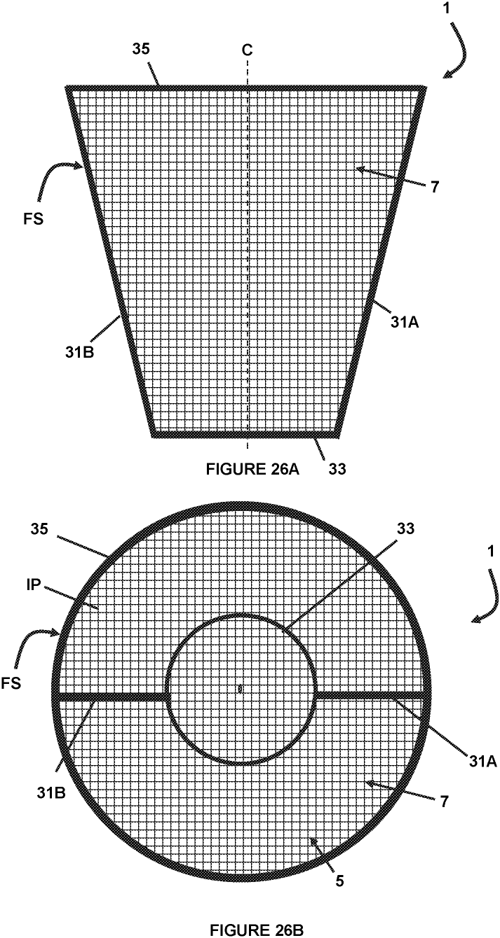

Alternatively, the structure 3 may include for example, a framework or support structure FS to which the at least one or plurality of wick structures 7 are attached or fixed. The structure 3 may, for example, include at least one or a plurality of posts, pillars or supports, for example, a first and a second pillar 31A, 31B as shown, for example, in FIGS. 26A and 26B. The pillars or supports 31 may comprise or consist of a metal, for example, aluminum, copper or steel (or a metallic alloy of any of aluminum, copper, or steel); or a ceramic; or a plastic, for example, a high temperature resistant plastic.

The pillars 31A, 31B extend upwards and are each attached, fixed or connected to the at least one or the plurality of wick structures 7. The pillars 31A, 31B may extend through openings (for example, openings 27) in the wick structure 7 or be attached to an inner or outer side or surface of the wick structure 7, or be attached to the upper and/or lower extremity 15, 19 of the wick structure 7.

The pillar or pillars 31A, 31B may, for example, be welded to the wick structure 7. Alternatively or additionally, the pillar or pillars 31A, 31B may, for example, include at least one or a plurality of attachment mechanisms, for example, clamps or clasps configured to be attached to the wick structure 7, for example, to the upper and/or lower extremities 15, 19 of the wick structure 7.

The attachment mechanism may comprise or consist of a metal, for example, aluminum, copper or steel (or a metallic alloy of any of aluminum, copper, or steel); or a ceramic or a plastic, for example, a high temperature resistant plastic. The attachment mechanism 11 may, for example, also include an electrical insulator, for example an electrical insulator layer, configured to electrically isolate the object being attached (that is the wick structure 7) from the pillars 31, if optionally desired.

While two pillars 31 are shown in FIGS. 16A and 16B, the aerosol generating device element 1 may include more than two pillars, for example, three or four pillars, for example, symmetrically or non-symmetrically spaced apart.

A plurality of wick structures 7 may be separately attached to the pillars 31A, 31B and separately located thereon.

The structure 3 may also, for example, include a lower enclosure or frame 33 at a lower extremity of the pillars 31A, 31B and extending between the pillars 31A, 31B and/or may also for example include an upper enclosure or frame 35 at an upper extremity of the pillars 31A, 31B and extending between the pillars 31A, 31B. Alternatively or additionally, one or more intermediate enclosures or frames may be present. The lower enclosure or frame 33 may define at least a portion of a base of the structure 3 and the vaporizer element 1. The upper enclosure or frame 35 may define a portion of the opening 17 through which the consumable CR is inserted into the vaporizer element 1.

One or more wick structures 7 may be attached to the lower and/orthe upper enclosures or frames 33, 35. The wick structure 7 may, for example, cover partially or fully an orifice defined by the lower frame 33 (see, for example, FIG. 26B). An orifice defined by the upper frame 35 remains uncovered to permit the consumable to be received therein.

The lower enclosure or frame 15 and the upper enclosure or frame 17 may comprise or consist of a metal, for example, aluminum, copper or steel (or a metallic alloy of any of aluminum, copper, or steel); or a ceramic; or a plastic, for example, a high temperature resistant plastic.

As, for example, illustrated in FIGS. 2 to 4 and FIGS. 8 to 10, the vaporizer element 1 or the structure 3 may also comprise at least one or a plurality of heating means (or heater or heater elements) 37, 39. The plurality of heaters 37, 39 are separately located on the structure 3. A non-limiting example of a plurality of heaters consisting of a lower heating means 37 and an upper heating means 39 is shown in FIG. 2. The at least one wick structure or plurality of wick structures 7 are in thermal contact with the heating means 37, 39.

The heating means 37, 39 may, for example, extend along at least an outer portion, and/or extend along at least one inner portion IP of the structure 3 to define at least one portion of the chamber 5.

For example, a heating means 37 may be located in or on the base 9 or define the base 9 or define a portion thereof.

The heating means 37 may define the base 9 or define a portion thereof and be configured or located to directly receive, from the consumable CR, the vaporizable material to be evaporated or vaporized. The wick structure 7 may be present or may be absent above at least a portion of the heating means 37 to permit the heating means 37 to directly receive the vapor or aerosol generating substance.

The heating means 37 and the wick structure 7 (or a portion thereof) may define the base 9 of the vaporizer element 1 or the structure 3. The wick structure 7 or a portion the mesh 7 may, for example, be located above the heating means 37 and/or between the heating means 37 and the consumable CR to be received. The heating means 37 may be located directly below a base, lower portion or lower apex of the consumable CR.

Alternatively or additionally, a heating means such as upper heating means 39 may be located in or on the at least one wall 11 or may define at least a portion of the at least one wall 11, or a plurality of spatially separated heating means 39 may be located in or on the at least one wall 11 or may define a plurality of portions of the at least one wall 11. A first and second heating means 39 can thus be located in or on the at least one wall 11 or each define at least a portion of the at least one wall 11 or only define at least a portion of the at least one wall 11. The first and second heating means may each define at least a portion of the chamber 5.

The vaporizer element 1 or the structure 3 may, for example, include a first or lower heating means 37 and a second or upper heating means 39, and the at least one wick structure 7 may extend fully or partially between the first and second heating means 37, 39. The wick structure 7 may only extend between the first and second heating means 37, 39.

The first heating means 37 can be, for example, located at the lower extremity 15 of the vaporizer element 1, and the second heating means 39 can be, for example, located between the opening 17 (or upper extremity 19) and the lower extremity 15. The second heating means 39 can alternatively be, for example, at the upper extremity of the at least one wall 11 and define the opening 17.

The structure 3 may include a first heating means 37 located in or on the base 9 or defining the base or defining a portion thereof; and a second heating means 39 located in or on the at least one wall 11 or defining at least a portion of the at least one wall 11.

The heating means 37, 39 may be attached to the wick structure 7 and directly or indirectly in contact with the wick structure 7. The attachment is, for example, a mechanical attachment.

The attachments may be assured using attachment mechanisms, such as, stitching or a plurality of annular or looped attachments. For example, a wire/thread may extend or loop through a portion or a plurality of portions located at the extremities of both the wick structure 7 and the heating means 37, 39 to attach or stitch the wick structure 7 and the heating means 37, 39 together. The wire/thread may comprise or consist of a metal, for example, aluminum, copper or steel (or a metallic alloy of any of aluminum, copper, or steel); or a plastic, for example, a high temperature resistant plastic.

Linking wires, strands or apertures may be included in both the wick structure 7 and the heating means 37, 39 to permit the wick structure 7 and the heating means 37, 39 to be attached to each other, for example using stitching or a plurality of closed annular or looped attachments that pass through each of the wick structure 7 and the heating means 37, 39

Alternatively or additionally, the heating means 37, 39 may be attached to the same framework or support structure FS as that of the wick structure 7. The heating means 37, 39 may be attached to the supports 9 in the same manner as that previously described in relation to the wick structure 7, that is, using identical attachment mechanisms as those described above.

FIG. 2 shows an exemplary embodiment in which the structure 3 includes the first heating means 37 located in or on the base 9 or defining the base 9 and the second heating means 39 defining at least a portion of the at least one wall 11. The structure 3 also includes an upper wick structure 7B and a lower wick structure 7A. The second heating means 39 is attached to a lower section of the upper wick structure 7B and to an upper section of the lower wick structure 7A. The first heating means 37 is attached only to a lower section of the lower wick structure 7A.

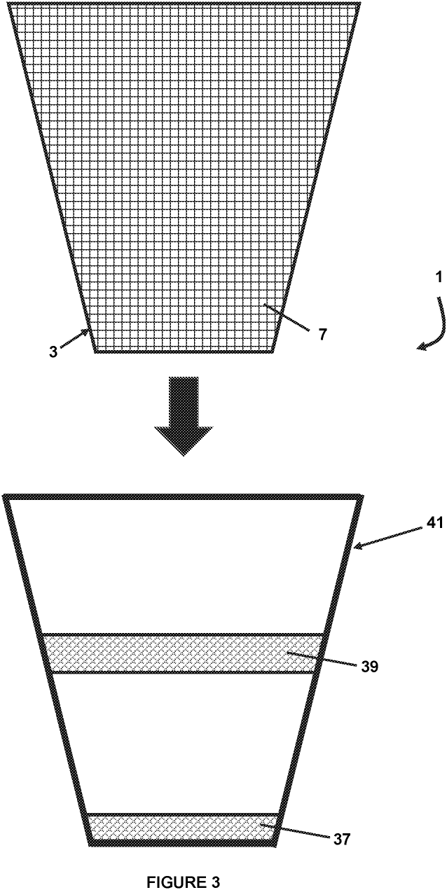

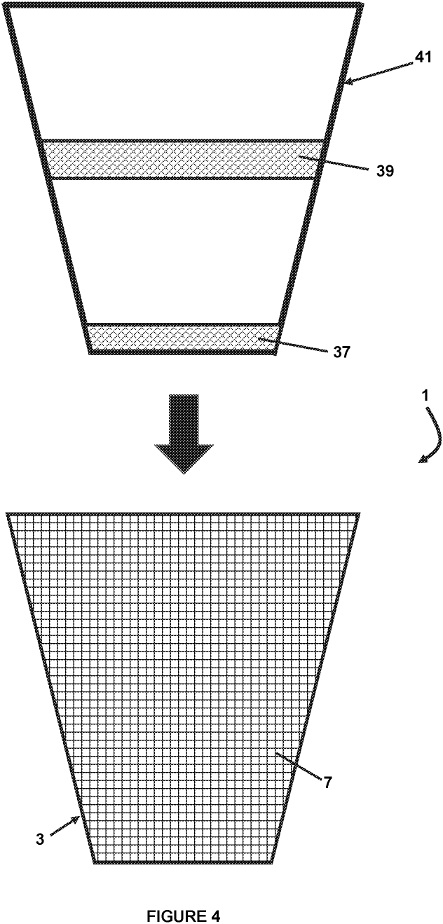

Alternatively, a framework or framework structure 41 may include at least one or a plurality of heating means attached thereto (see for example, FIGS. 3 and 4). The framework or framework structure 41 may include, for example, the first heating means 37 attached at a lower section or base of the framework 41 and the second heating means 39 attached at an intermediate section or other section of the framework 41.

The framework or framework structure 41 may, for example, be identical or similar to the framework or framework structure FS previously described and shown, for example, in FIGS. 26A and 26B. The first heating means 37 is, for example, attached to the lower enclosure or frame 33 and the second heating means 39 attached to the pillars 31A, 31B at a location between the lower frame 33 and the upper frame 35. Such an attachment can optionally be carried out via an intermediate frame or enclosure (non-illustrated).

The wick structure 7 can, for example, be attached to the framework structure 41 by a form-fit or press-fit. The wick structure may, for example, have a complementary or corresponding shape to the framework structure 41 allowing it to be snuggly received inside the framework structure 41 as shown for example in FIG. 3. Alternatively, the framework structure 41 may, for example, have a complementary or corresponding shape to the wick structure 7 allowing it to be snuggly received inside the wick structure 7 as shown for example in FIG. 4. One or more attachment mechanisms, such as clips or clamps, may also be included, for example, to attach a portion of the framework structure 41 to at least one wall of the wick structure 7. The structure 3 may, for example, may be the same structure 3 as previously described, may comprise or consist of a stand-alone wick structure 7, or alternatively may include the framework structure FS, as previously described. The wick structure 7 may, for example, define a conical structure as shown in the exemplary embodiment of FIGS. 1A, 1B and 3 to 4.

The plurality of heaters, or the first and second heaters 37, 39 can be, for example, located to be in fluidic or liquid communication, or interconnected via a fluid or liquid interconnection.

The first and second heaters 37, 39 can be located along at least one fluidic communication path/trajectory FCP or fluid flow path/trajectory FCP of a liquid provided by the vaporizable material and the consumable CR.

The fluidic communication path FCP defines a path or trajectory along which the liquid extends or flows when released onto the structure 3 or heater 37, 39 from the consumable CR.

The fluidic communication path FCP may, for example, comprise or pass through/along at least one portion the first heater 37 and at least one portion of the second heater 39; or at least one portion the first heater 37, at least one portion of the second heater 39 and the wick structure 7 between the first and second heaters 37, 39.

FIG. 2 shows a non-limiting example of a location of the fluidic communication path FCP on the vaporizer element 1.

The fluidic communication path FCP may, for example, only comprise or pass through/along at least one portion of the heating means and the wick structure 7, for example the first or second heating means 37, 39 and the wick structure 7.

The fluidic communication path FCP may, for example, only comprise or pass through/along at least one portion of the wick structure 7, for example, for a structure 3 heated via induction or electromagnetic radiation heating.

The fluidic communication path FCP is associated with or in contact (directly or indirectly) with a release aperture or orifice of the consumable through which the liquid or vaporizable material is released as will be explained further below.

Advantageously, the plurality of heating means 37, 39 (or each heating means 37,39) are configured to generate different vaporization heating temperatures to heat liquid or vaporizable material at different temperatures.

For example, the first heating means 37 can be configured to generate a first vaporization heating temperature and the second heating means 39 can be configured to generate a second vaporization heating temperature different to the first vaporization heating temperature.

The first heating means 37 may provide a lower or a higher heating temperature than the second heating means 39.

For example, the lower heating meanings 37 may have a resistance value or resistivity value to provide a higher heating temperature than the upper heating means 39, or vice versa.

The liquid or the vaporizable material can thus be vaporized at different temperatures as the liquid or the vaporizable material extends along the fluidic communication path FCP.

The at least one heating means 37, 39 or the plurality of heating means 37, 39 may, for example, be configured to displace the received liquid from the consumable by capillary action or by a capillary force.

The heating means 37, 39 may, for example, comprise or consist of one or a plurality of wires, filaments or strands. The one or the plurality of heating wires, filaments or strands may extend to define a plurality of open pores or openings configured to displace the liquid or the vaporizable material in the heater/heating means 37, 39 by capillary action or by a capillary force. The open pores or openings may, for example, have an opening width or diameter of between 10 µm and 1000 µm, or between 10 µm and 500 µm.

The one or the plurality of wires, filaments or strands may, for example, be intertwined, interlaced or interwoven to define the plurality of pores.

Heat can be, for example, generated through Ohmic or resistive heating by passing a current through the heating means 37, 39.

The heating means 37, 39 may, for example, comprise or consist of an electrically conductive material. The wires, for example, may comprise or consist of a metal. The metal may, for example, comprise or consist of aluminum, copper, gold, silver or steel, or a metallic alloys of any of aluminum, copper, gold or steel.

The electrically conductivity of the heater/heating means material can be, for example, higher than that of the liquid or the vaporizable material, for example, at least between 2 and 10 times higher. An electrical current provided to the heater/heating means flows through the heater/heating means to generate heat for vaporization of the liquid.

Alternatively, or additionally, heat may be generated by the heating means 37, 39 and/or the wick structure or structures 7 via induction or electromagnetic radiation heating. A structure 3 comprising or consisting of one or more wick structures 7 and not including the above-mentioned heating means 37, 39 may thus provide heat energy for vaporization via induction or electromagnetic radiation heating.

Alternatively, a structure 3 comprising or consisting of one or more wick structures 7 as well as the heating means 37, 39 may provide heat energy for vaporization via induction or electromagnetic radiation heating in the one or more wick structures 7. The aerosol generating device AGD may be configured to provide heat, for example simultaneously, via (i) induction or electromagnetic radiation heating and/or (ii) Ohmic heating in via the heating means 37, 39. This allows different vaporization temperatures to be obtained at different locations on the vaporizer element 1.

The at least one or the plurality of heating means 37, 39 may define, for example, portions or sections on the structure 3 distinct from those of the wick structure 7. The at least one or the plurality of heating means 37, 39 can be, for example, configured to heat at one or more temperatures (or temperature ranges) distinct to that of the wick structure 7 when the wick structure 7 generates heat via induction or electromagnetic radiation heating. This can be determined, for example, by the values of the physical dimensions (length, thickness, circumference) of the constituent elements (such as wires or filaments) of the heating means 37, 39 and the resistivity of the constituent material of the heating means 37, 39.

An aerosol generating device AGD comprising the vaporizer element 1 may also include, for example, a generator configured to generate an alternating electromagnetic field or electromagnetic radiation as well as at least one or a plurality of susceptors configured to generate heat following absorption of the generated electromagnetic radiation. The at least one or the plurality of susceptors are located in a chamber of the aerosol generating device to surround at least a portion of the one or more heating means 37, 39 and/or the wick structure or structures 7 and located to permit heat transfer the one or more heating means 37, 39 and/or the wick structure or structures 7 from the at least one or the plurality of susceptors permitting to vaporize a liquid or vaporizable material.

The aerosol generating device AGD may, for example, alternatively include an optical electromagnetic radiation source to provide electromagnetic radiation for absorption in at least one or a plurality of absorber elements or layers provided on at least a portion of the one or more heating means 37, 39 and/or the wick structure or structures 7. The at least one absorber element or layer is configured to absorb the emitted electromagnetic radiation of the optical electromagnetic radiation source and to generate heat energy that can vaporize a vapor or aerosol generating substance. The optical electromagnetic radiation source may, for example, comprise or consist of at least one laser (such as a diode laser) or at least one high-power LED. The provision of absorber elements or layers is not necessary in the case where the optical electromagnetic radiation is absorbed by the constituent material of the one or more heating means 37, 39 and/or the mesh structure or structures 7 to generate heat (inherently absorbing at the source wavelength).

In the case, where the wick structure or structures 7 of the structure 3 generate the heat energy to vaporize the vapor or aerosol generating substance, the one or more heating means 37, 39 may be absent from the structure 3.

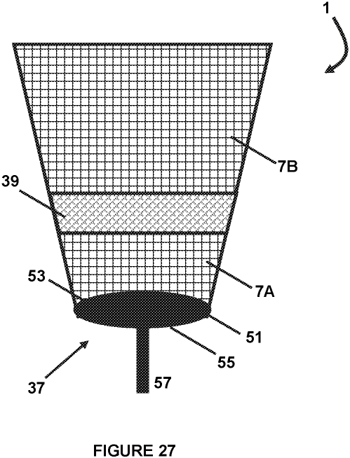

In another embodiment of the present disclosure, the first heating means 37 may be, for example, a bottom or lower heater 37 comprising or consisting of a planar/solid body or plate 51 extending to define the base 9 of the vaporizer element 1 (see, for example, FIG. 27). The planar body 51 extends, for example, to close the base 9 of the aerosol generating device element 1. The elongated body 51 extends, for example, in a direction or plane extending perpendicularto an insertion direction ID (see, for example, FIG. 1A) of the consumable CR into the aerosol generating device element 1.

The planar body 51 defines an upper surface 53 for receiving directly or indirectly the vaporizable material or liquid from the consumable CR. The planar body 51 also defines a lower surface 55 to which, for example, a member such as a pin 57 can be attached. The pin 57 is configured, for example, to permit the heater 37 to be attached inside the aerosol generating device and/or to define electrical contacts for providing a current to the heater 37.

A wick structure 7, for example, the lower wick structure 7A may be attached to planar body 51 using the attachment mechanisms previously described, for example, by clamping or by an interconnecting wire or filament interconnecting a lower section of the lower wick structure 7A with apertures or hooks provided on the planar body 51, for example, around a periphery of the planar body 51. Alternatively, the lower wick structure 7A may extend to surround the planar body 51 and extend under the lower surface 55 and be attached to the lower surface 55 and/or the pin 57.

The lower wick structure 7A may, for example, extend across at least a portion of the upper surface 53. The lower wick structure 7A may, for example, extend along portions of the periphery of the planar body 51. This can facilitate displacement of the liquid or vaporizable material along the wick structure 7A and the wall 11. This can facilitate displacement of the vapor or aerosol generating substance upwards and towards or to, for example, a second heater 39 defining a section of the wall 11.

The planar body 51 may, for example, include one or more heating wires to generate heat through Ohmic or resistive heating by passing a current through the heating wires. Alternatively, or additionally, the heater 37 may generate heat via induction or electromagnetic radiation heating in the manner previously described above.

The planar body 51 may, for example, comprise or consist of at least one metal, for example, aluminum, copper or steel or a metallic alloy of any of aluminum, copper, or steel), or a ceramic.

The heater/heating means 37, 39 may, for example, comprise or consist of a mesh or a meshed structure, for example, the mesh structure whose details are provided previously in this disclosure and for which exemplary embodiments are shown in FIGS. 25A to 25C.

Alternatively, or additionally, the heating means may comprise or consist of a braided conductor heating element. For example, in the exemplary embodiment of FIG. 27, the second or upper heating means 39 located in or on the at least one wall 11 or defining at least a portion of the at least one wall 11 may comprise or consist of a braided conductor heating element. However, the at least one or the plurality of heating means 37, 39 may comprise or consist of a braided conductor heating element.

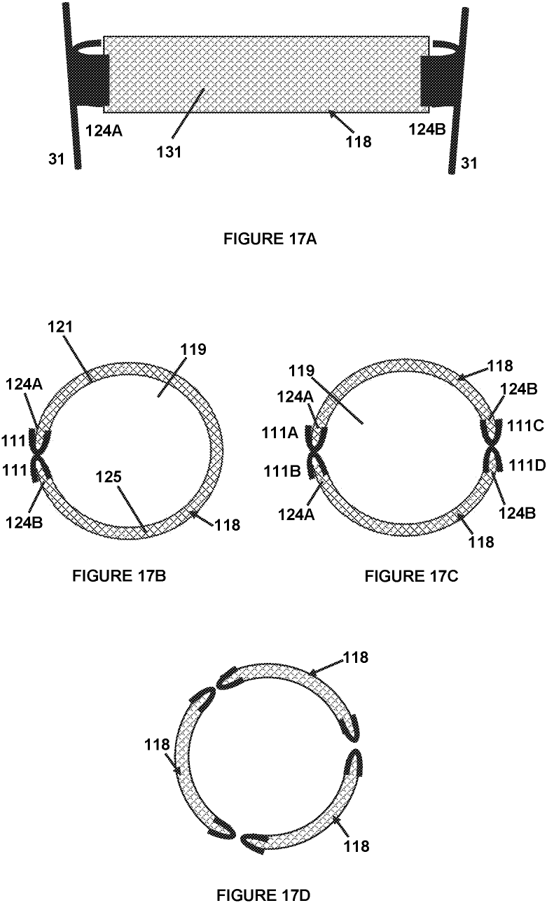

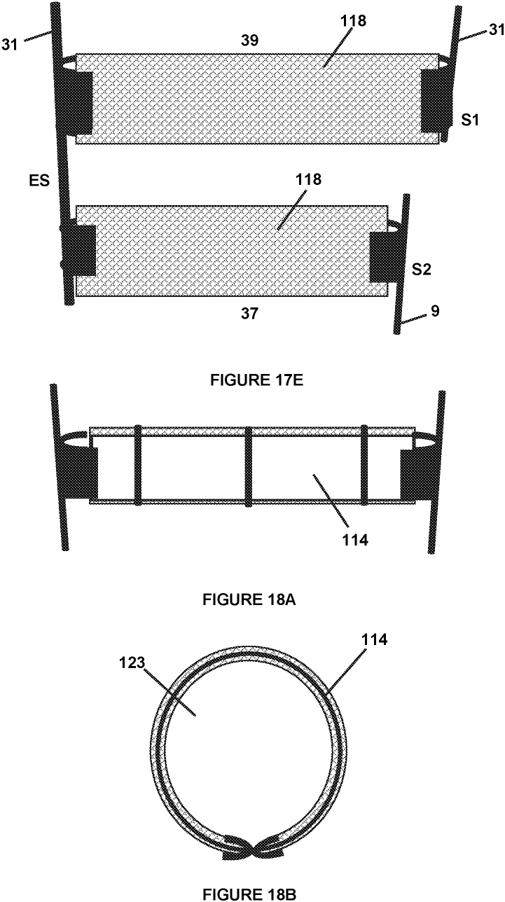

The braided conductor heating element comprises or consists of, for example, at least one elongated member or structure 118, an upper opening 121 and a lower opening 123 (see, for example, FIGS. 17A to 17C). The at least one elongated member or structure 118 defines, for example, an enclosure 119, as well as the upper opening 121 and the lower opening 123.

The enclosure 119 is configured to receive and hold therein at least a portion of the consumable CR containing or holding the vaporizable material. The at least one elongated member or structure 118 of the heater is, for example, configured to be in contact (directly or indirectly) with at least a portion of the consumable CR when the consumable is positioned in the heating element 1.

The braided conductor heating element comprises or consists of, for example, at least one elongated member or structure 118 or a plurality of elongated members or structures 118 (see for example FIGS. 17A to 17D). The elongated member or structure 118 may include a first longitudinal extremity 124A and a second longitudinal extremity 124B, and extends longitudinally or lengthwise between these first and second extremities 124A, 124B. The at least one elongated member or structure 118 extends longitudinally to define, for example, a band or a belt. The elongated member or structure 118 may also include an upper perimeter 125A and a lower perimeter, and extends between the upper and lower perimeters.

The longitudinal extremities 124A, 124B may be attached to attachment mechanisms 111. The attachment mechanisms 111 may, for example, comprise or consist of clamps or clasps configured to be attached, to the extremities 124A, 124B as shown schematically in FIGS. 17A and 17B.

The first and second extremities 124A, 124B may be directly or indirectly in contact or may not be in contact. For example, FIG. 17B shows a single elongated member or structure 118 where the first and second extremities 124A, 124B are indirectly in contact via the attachment mechanism 111. FIG. 17C shows, for example, a plurality of elongated members or structures 118 whose extremities 124A, 124B are also indirectly in contact with each other via the attachment mechanisms 111. FIG. 17D shows, for example, a plurality of elongated members or structures 118 where first and second extremities 124A, 124B are indirectly in contact via the elements of the structure 3 or framework structure 41, for example, via supports 31A, 31B and/or the lower frame 33 and/or the upper frame 35.

FIG. 17E shows another structure or framework 3, 41 portion that can form part of the chamber 5 and in which the first and second heaters 37, 39 are attached on one side to a shared elongated section ES of the pillar 31 and opposite sections S1, S2 are free to be displaced to the shared elongated section ES and to define a desired profile of the heaters 37, 39 and of the chamber 5.

The at least one elongated member or structure 118 is, for example, flexible and configured to be contoured, bent or shaped to define a desired profile or shape.

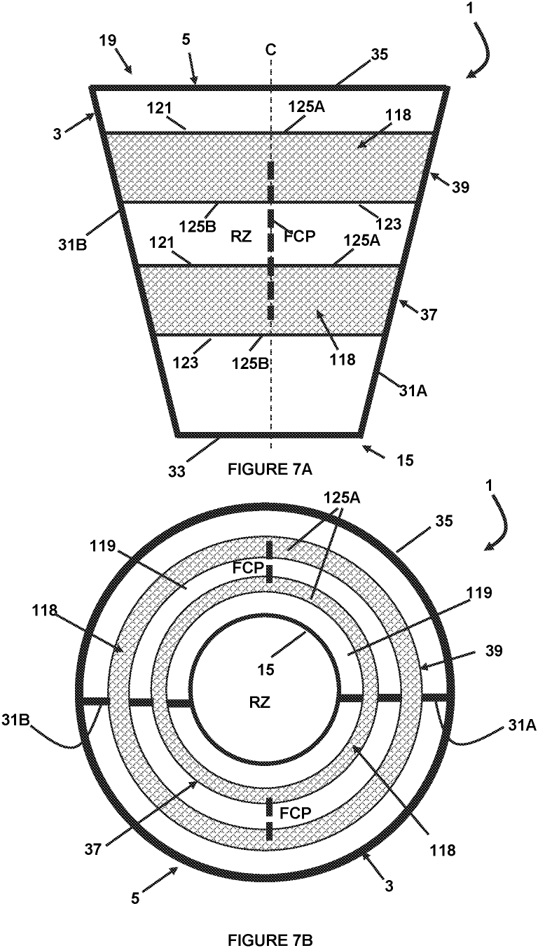

In the exemplary non-limiting embodiment of FIG. 17B or FIGS. 7A and 7B, the elongated member or structure 118 has a (substantially) circular cross-sectional profile. The elongated member or structure 118 may, for example, extend downwards between the upper and lower perimeters to converge inwardly in a direction extending towards a center C (see, for example, FIG. 1A) of the vaporizer element 1. The elongated member or structure 118 thus comprises or defines at least a sloped inner wall or surface.

The elongated member or structure 118 may delimit a conical shape or truncated conical profile.

In the non-limiting example shown in FIG. 7A, the elongated member or structure 118 of each of the heaters 37, 39 delimits a conical shape. The supports 31 when extending downwards converge inwardly in the direction extending towards a center C of the aerosol generating device element or heating element 1 and together with the elongated members or structures 118 delimits a conical shape or truncated conical profile.

The lower frame 33 and/or the upper frame 35 may be included and, for example, may delimit an annular form as shown in the exemplary embodiment of FIG. 7B. The lower frame 33 defines a smaller circumferential length, width or diameter than that of the upper frame 35.

As mentioned above, in one exemplary embodiment, the heater 37, 39 may, for example, comprise or consist of a braided conductor heating element. The braided conductor heating element (and, in particular, the elongated member or structure 118) comprises or consists of at least one braid 127 (or a plurality of braids 127). The braid is defined by at least one or a plurality of elongated conductive members or elements 129. The braided conductor heating elements (in particular, the elongated member or structure 118) comprises or consists of an intertwined network or structure 127, or a braid/braided network or structure 127 of elongated conductive elements 129. The braid, or intertwined network or braid/braided network 127 is, for example, configured to receive the liquid or vaporizable material thereon.

FIGS. 23A and 23B show portions of non-limiting exemplary patterns and profiles of the braid, braided structure or braided network 127.

The braid, braided structure or braided network 127 may extend partially or fully between the first and second longitudinal extremities 124A, 124B and/or may extend partially or fully between the upper and lower perimeters of the elongated member or structure 118.

The braid, braided structure or braided network 127 includes a plurality of elongated conductive elements 129 intertwined, interlaced or plaited together. The elongated conductive elements 129 may, for example, comprise or consist of wires, strands, strips, filaments, or yarns.

The plurality of elongated conductive elements 129 may, for example, include two, three (at least three) or more than three individual elongated conductive elements 129. The intertwined or interlaced elongated conductive elements 129 may extend partially or fully between the first and second longitudinal extremities 124A, 124B and/or may extend partially or fully between the upper and lower perimeters of the elongated member or structure 118.

Elongated conductive elements 129 are, for example, intertwined or interlaced together to cross over or under one another as they extend through the braided structure 127.

In a non-limiting exemplary braided structure 127, each or individual elongated conductive elements 129 may propagate or extend to pass under or over a next encountered elongated conductive element 129 encountered during propagation along the structure 127, or propagate to pass under or over each of a next encountered elongated conductive element 129 encountered during propagation along the structure 127.

Each or individual elongated conductive elements 129 may, for example, propagate to pass under at least one or a plurality of next encountered elongated conductive elements 129 and then pass over at least one or a plurality of next encountered elongated conductive elements 129. Propagation may continue in such a manner across the structure 127.

A group of individual elongated conductive elements 129 may, for example, propagate as set out above across the structure 127, the individual elongated conductive elements 129 of the group propagating parallel or substantially parallel to each other.

Each elongated conductive element 129 or individual elongated conductive elements 129 may propagate or extend to define a same angle (or substantially the same angle) with an encountered other elongated conductive element or elements 129.

FIGS. 23A to 23C shows exemplary patterns formed in such a manner.

In another non-limiting exemplary braided structure 127, each or individual elongated conductive elements 129 may propagate or extend to pass under or over a first neighboring elongated conductive element 129, and further propagate to pass under or over at least one other neighboring elongated conductive element 129 different to the first neighboring elongated conductive element 129. Propagation may, for example, then pass again under or over the first neighboring elongated conductive element 129 and continue in such a manner.

FIG. 23D shows an example of such propagation for three elongated conductive elements A, B, C.

Each or individual elongated conductive elements 129 may propagate or extend in a zig-zag or crisscross manner.

The elongated conductive elements 129 are, for example, mechanically interlocked with one another.

The elongated conductive elements 129 are, for example, mobile to move with respect to each other at an intersection where elongated conductive elements 129 cross one another. The elongated conductive elements 129 are, for example, mobile to displace the intersection.

An individual elongated conductive element 129 (or a plurality thereof) is non-twisted or non-fully twisted with or around another elongated conductive elements 129 as it propagates or extends through in the structure 127. For example, no two elongated conductive elements 129 are fully twisted around one another.

The braid, braided structure or braided network 127 is configured to hold or retain the liquid or the vaporizable material.

The longitudinal extremities 124A, 124B may comprise or consist of the outer extremity of at least one or a plurality of wires or strands 129, as shown, for example in FIG. 24B.

The braided structure 127 may, for example, define at least one layer, sheet or tape. The braided structure 127 may, for example, define a sleeve or flattened elongated tube, for example, comprising an imploded or collapsed innerwall. The braided structure 127 may comprise a flattened structure.

The braided structure 127 may, for example, be or define a two-dimensional or three-dimensional braid.

The braided structure 127 is, for example, configured to displace the received liquid or the received vaporizable material through the heater/heating means by capillary action or by a capillary force.

The braided structure 127 may, for example, define an open configuration (see for example, FIGS. 23 and 24) in which openings or pores are defined between intertwined elongated conductive elements 129. The defined pores of the braided structure 127 are, for example, configured to displace the received liquid or the received vaporizable material through or across the heater/heating means by capillary action or by a capillary force.

The pores or openings may, for example, have an opening width or diameter of between 10 µm and 1000 µm, or between 10 µm and 500 µm.

The braided structure 127 may, for example, include or consist of one braid pattern or a plurality of different braid patterns. Non-limiting braid patterns include known braid patterns such as, for example, a Hercules braid or triple overlap braid (FIG. 23A), a regular braid or double overlap braid (FIG. 23B) and a diamond braid or single overlap braid (FIG. 23C). The braid pattern or patterns are configured to hold or retain at least one e-liquid or at least one vapor or aerosol generating substance.

The braided structure 127 may be a freestanding braided structure that is included in the elongated member or structure 118. That is, the braided structure 127 is self-supporting and/or not-braided onto an underlying or internal support.

The elongated member or structure 118 may include one or more linking wires or strands (not-shown) that are non-braided and extend through and across the braided structure 127 between the first and second longitudinal extremities 124A, 124B. The linking wires may be located, for example, at the upper and lower perimeters of the elongated member or structure 118. The linking wires may, for example, be used to attach further elements to the braided conductor heating elements, such as for example the wick structure 7.

A flexible blade 114, may for example, be attached to a facet 131 of the braided structure 127 as, for example, shown in FIG. 18A. Alternatively, the braided structure 127 may enclose or surround (fully or partially) the flexible blade 114 as, for example, shown in FIG. 18B.

The blade 114 can be, for example, attached to the braided conductor heating element by one or more clasps and/or clamps as, for example, shown in FIG. 18A. The blade 114 may be flexible and/or define an elongated planar sheet. The blade 114 may comprise or consist of a metal, for example, copper or aluminum, or a metallic alloys of any of aluminum, copper or steel.

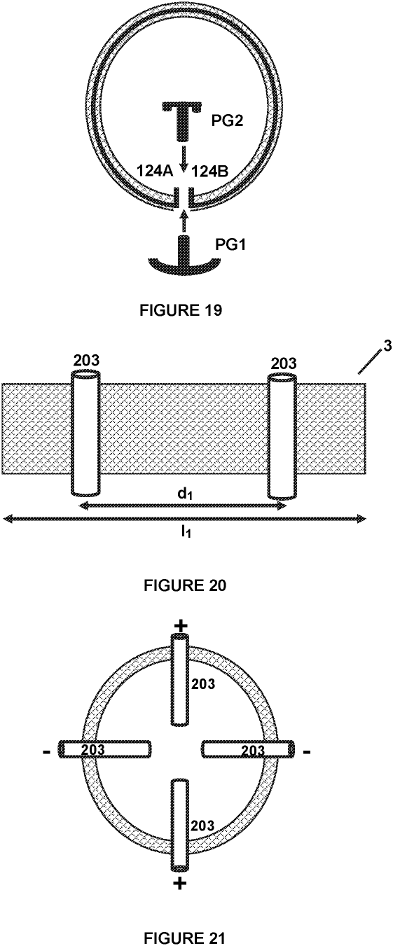

FIG. 19 schematically shows an alternative mechanism for defining an enclosure profile of a braided conductor heating element that includes a blade 114, the mechanism comprises a plug that is configured to be retained by press fit between extremities of the braided conductor heating element.

Each elongated conductive element 129 of the plurality of elongated conductive elements 129 may comprise or consist of the same material or of a mix of different materials. The material is electrically conductive and thermally conductive. The elongated conductive element 129 may, for example, comprise or consist of a metal. The elongated conductive elements 129 may all comprise or consist of the same metal or a mix of different metals (or at least one of the materials used in a mix of materials comprises or consists of a metal or is electrically and thermally conductive). The metal may, for example, comprise or consist of aluminum, copper, gold, silver or steel, or a metallic alloy of any of aluminum, copper, gold or steel.

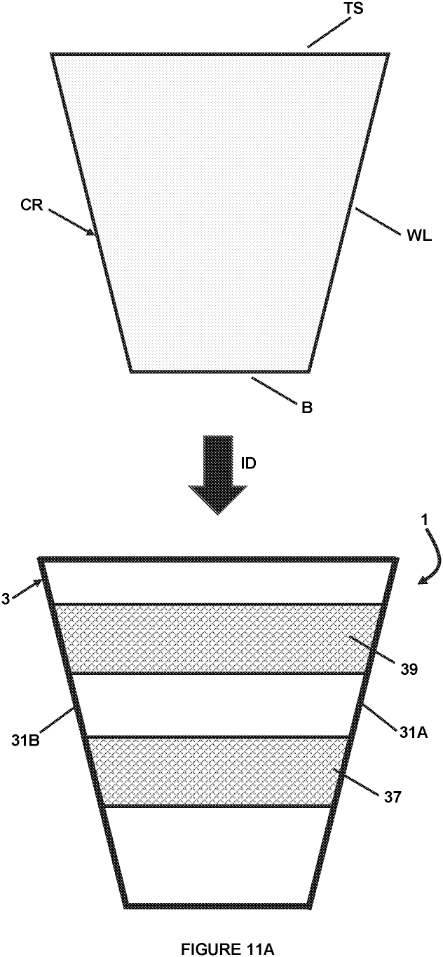

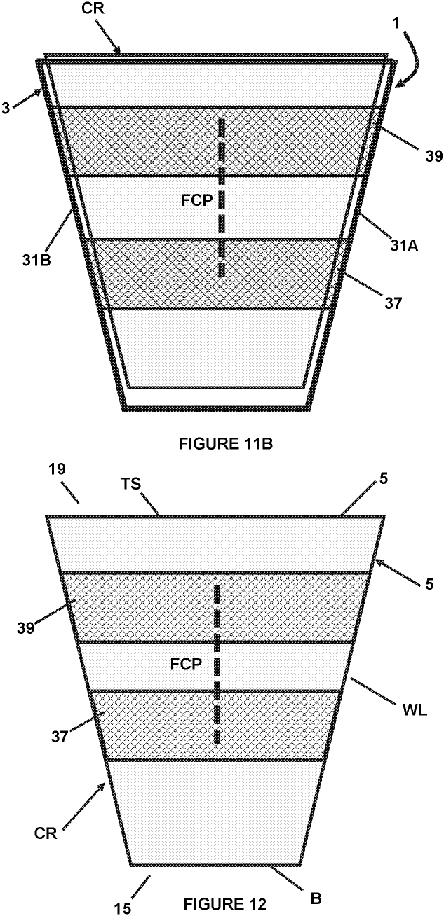

The braided conductor heating elements 37,39 define walls of the chamber or holder 5. The walls and more particularly an inner surface of each wall defines an enclosure configured to receive the consumable CR. FIG. 11B shows the consumable CR in contact with the inner surface of the walls and held in the holder 5. The first braided conductor heating element 37 extends to define a wall or at least a portion of at least one wall of the holder 5. The second braided conductor heating element 39 extends to define a further wall or at least a portion of at least one further wall of the holder 5.

Each of the first and second braided conductor heating elements 37, 39 may extend circumferentially or peripherally on the holder 5 to each define at least one wall or define wall portions of the holder 5.

The braided conductor heating element of the upper heater 39 may, for example, be configured to provide a different heating temperature to that of another heater such as the lower heater 37. For example, the braided conductor heating element 39 may provide a lower or a higher heating temperature than that of the lower heater 37.

For example, the length or peripheral/circumferential length of the braided conductor heating element of the upper heater 39 and/or a resistance value or resistivity value braided conductor heating element of the upper heater 39 can be determined and set to define the desired heating temperature provided by the braided conductor heating element of the upper heater 39. A plurality of heaters can thus provide different vaporization temperatures at different locations along the vaporizer element 1.

The inclusion of a plurality of heating means or a plurality of braided conductor heating elements permits the aerosol generating device element 1 to provide different heating temperatures at different locations between the upper and lower extremities the vaporizer element 1 and to provide a heating temperature gradient.

The first and second heating means 37, 39 may comprise or consist of a braided conductor heating element. The aerosol generating device element 1 may comprise more than two braided conductor heating elements. For example, 3, 4, 5, 6, 7, 8, 9, or 10 braided conductor heating elements.

Each of the heating means or the first and second heating means 37, 39 are configured to be individually controlled and located to define two separate heating zones. This permits different temperatures or a temperature gradient to be provided across the structure 3 and the wick structure or structures 7. This permits, for example, selective evaporation of constituents of the vaporizable substance.

The liquid or the vaporizable material can thus be vaporized at different temperatures as the liquid or the vaporizable material extends along the fluidic communication path FCP.

While the elongated conductive element 129 shown in FIGS. 23 and 24 show elongated conductive elements 129 having a (substantially) regular or uniform profile, for example, extending in a straight direction and having a width and/or thickness that is substantially the same along the extension direction of the elongated conductive element 129, it should be noted that the elongated conductive element 129 may define a non-regular or non-uniform profile. The elongated conductive element 129 may, for example, extend in a serpentine manner and have a width and/or thickness that varies along the serpentine extension direction. A non-limiting exemplary non-uniform profile is for example shown in FIG. 23E.

FIG. 7A shows a schematic side view of another exemplary implementation of a vaporizer element or heating element 1 according to the present disclosure, and FIG. 7B shows a schematic top view thereof. The vaporizer element or heating element 1 of FIGS. 7A and 7B is similar to the heating element of the upper portion of FIG. 3 and to that of the lower portion of FIG. 4.

The heating element 1 includes a plurality of heating means or heaters 37, 39, for example, the first heater 37 and a second heater 39 as well as the framework structure or framework 41 defining the chamber 5. As previously mentioned, the chamber 5 is configured to receive and/or (temporarily) hold at least one vaporizable material. Alternatively or additionally, the chamber 5 is configured to receive and/or hold the consumable CR containing or holding the at least one vaporizable material.

The structure 3 includes the first and second heaters 37, 39. Each of the first and second heaters 37, 39 separately extend to each define a portion of the chamber 5.

The plurality of heaters 37, 39 or the first and second heaters 37, 39 are separately located on the structure 3 and located to be in fluidic or liquid communication, or interconnected via a fluid or liquid connection.

The first and second heaters 37, 39 are located along the at least one fluidic communication path/trajectory FCP or fluid flow path/trajectory FCP of the at least one vaporizable material.

The fluidic communication path FCP defines a path or trajectory along which the at least one vaporizable material extends or flows when released onto the structure 3 or heater 37, 39 or released from the structure or chamber of the consumable CR.

The fluidic communication path FCP may, for example, comprise or pass through/along at least one portion the second heater 39 and at least one portion of the first heater 37, or at least one portion the second heater 39, at least one portion of the first heater 37 and an inter-spacing between the first and second heaters 37, 39.

The fluidic communication path FCP may, for example, comprise or pass through/along at least one portion of the second heater 39, at least one portion of the first heater 37 and at least one portion of the structure 3.

FIGS. 7A and 7B show non-limiting examples of a location of the fluidic communication path FCP on the heating element 1. The fluidic communication path FCP is associated or in contact (directly or indirectly) with a release aperture or orifice of the consumable CR through which vaporizable material is released as will be explained further below.

Advantageously, as mentioned previously, the heaters 37, 39 (or each of the heaters 37, 39) can be configured to generate different vaporization heating temperatures to heat vaporizable material at different temperatures.

For example, the second heater 39 can be configured to generate a second vaporization heating temperature and the first heater 37 can be configured to generate a first vaporization heating temperature different to the second vaporization heating temperature.

For example, the second heater 39 may provide a lower or a higher heating temperature than the first heater 37.

For example, the first heater 37 may be shorter in length or peripheral/circumferential length (as for example shown in FIG. 7B) relative to the second heater 39 to provide a lower heating temperature assuming that the same material is used in both the first and second heaters 37,39 or that the first and second heaters have the same material resistivity.

Alternatively, for example, the first heater 37 has a resistance value or resistivity value that compensates for a shorter length or peripheral/circumferential length relative to the second heater 39 to provide a higher heating temperature than the second heater 39.

Vaporizable material can thus be vaporized at different temperatures as vaporizable material extends along the fluidic communication path FCP.

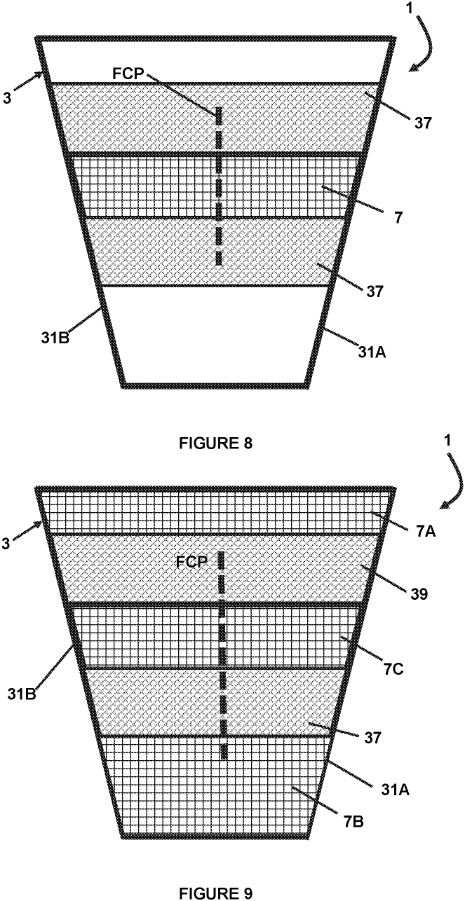

The aerosol generating device element 1, or the aerosol generating device vaporizer element or heating element 1 of the exemplary embodiment of FIGS. 7A and 7B may include the at least one wick structure 7 or a plurality of wick structures 7A, 7B (see, for example, FIGS. 8, 9, 10A and 10B). However, it should be noted that in accordance with another embodiment of the present disclosure, the at least one wick structure 7 or the plurality of wick structures 7A, 7B are absent or not necessarily included, and may be optionally included.

The structure 3 includes, for example, at least one or a plurality of posts, pillars or supports 31A, 31B, for example, the first and a second pillar 31A, 31B as shown, for example, in FIGS. 7A and 7B. The pillars or supports 31 may comprise or consist of a metal, for example, aluminum, copper or steel; or a ceramic; or a plastic, for example, a high temperature resistant plastic.

The pillars 31A, 31B extend upwards towards the heaters 37, 39 and are each attached, fixed or connected to the first and second heaters 37, 39. The pillars 31A, 31B may extend through each of the first and second heaters 37, 39, or be attached to an inner or outer side or surface of the heaters 37, 39, or be attached to at least one extremity or each extremity of the heaters 37, 39.

The pillar or pillars 31A, 31B may, for example, be welded to the heater 37, 39. Alternatively or additionally, the pillar or pillars 31A, 31B may, for example, include at least one or a plurality of attachment mechanisms 111, for example, clamps or clasps 111 configured to be attached to the heaters 37, 39, for example, to the extremities of the heaters 37, 39 as shown schematically in FIGS. 17A and 17B and described previously above.

The attachment mechanism 111 may comprise or consist of a metal, for example, aluminum, copper or steel, or a ceramic; or a plastic, for example, a high temperature plastic. In one embodiment, the attachment mechanism 111 may, for example, also include an electrical insulator, for example an electrical insulator layer, configured to electrically isolate the heater 37, 39 from the pillars 31 and the structure 3.

The pillars 31A, 31B may, for example, extend upwards firstly to the first heater 37 and then extend through a space to the second heater 9. The pillars 31A, 31B may, for example, continue to extend upwards beyond the second heater 39.

In one exemplary embodiment, the first pillar or support 31A may include a first and second attachment mechanism for example first and second clamps 111, such as that shown in FIGS. 17B or 17C, each clamped to an extremity of the lower or first heater 37. The first pillar or support 31A may then extend to the second or upper heater 39 to which it is attached, for example, also by clasping or clamping or alternatively by another attachment or gripping means or mechanism such as a weld or an adhesive. As mentioned above, the first pillar or support 31A may alternatively or additionally extend through or inside the first or lower heater 37.

The second pillar or support 31B (see, for example, FIG. 7A) may also include attachment mechanisms, for example, a third and fourth clamps 111, as shown for instance in FIGS. 17B or 17C, each clamped to an extremity of the first or lower heater 37. The second pillar or support 31B may also be attached to the second or upper heater 39 in a similar manner to those mentioned above in relation to the first pillar or support 31A and the second or upper heater 39.

In an alternative exemplary embodiment, the first pillar or support 31A includes a first attachment mechanism such as a first clamp 111A and a second attachment mechanism such as a second clamp 111B, as for example schematically shown in FIG. 17C, and the first clamp 111A is attached to a first heater 37A and the second clamp 111B is attached to second heater 37B.

The second pillar or support 31B includes a third attachment mechanism such as a third clamp 111C and a fourth attachment mechanism such as a fourth clamp 111D, as for example schematically shown in FIG. 111C, and the third clamp 111C is attached to first heater 37A and the fourth clamp 111D is attached to second heater 37B. The first and second heaters 37A, 37B form or define a lower heater element or structure 37. An upper heater element or structure 39 (not shown) separated from the lower heater element or structure 37 can be formed in an identical manner.

While two pillars 31 are shown in FIGS. 7A and 7B, the heating element 1 may include more than two pillars, for example, three or four pillars, for example, symmetrically spaced apart.

As mentioned above, FIG. 17E shows another structure or framework 3 portion that can form part of the chamber 5 and in which the first and second heaters 37, 39 are attached on one side to a shared elongated section ES of the pillar 31 and opposite sections S1, S2 are free to be displaced to the shared elongated section ES and to define a desired profile of the heaters 37, 39 and of the chamber 5.

While described in relation to FIGS. 7A and 7B, the above description of the pillars 31 of the structure 3 and associated attachments equally applies to the other embodiments of the present disclosure in which pillars 31 are included.

The heating means or heaters 37, 39 may comprises or consists of any of the previously above-described heater structures. For example, the first heater and/or the second heater 37, 39 may comprise or consist of a braided conductor heating element or a mesh (meshed structured heating element), as described previously. The braided conductor heating elements may, for example, define an intertwined or interlaced network for receiving the at least one vaporizable material. For example, the braided conductor heating element or elements may include braided wire 127 and a flexible substrate or blade 114 to which the braided wire 127 is attached, or includes braided wire 127 and at least one clamp 111 to which the braided wire is attached, as described previously above.

As previously described above, the heater (or heaters) 37, 39 is, for example, configured to displace the received vaporizable material or substrate through the heater structure by capillary action or by a capillary force.

The structure 3 may also include a lower enclosure or frame 15 (see, for example, FIGS. 7A and 7B) at a lower extremity of the pillars 31A, 31B and extending between the pillars 31A, 31B and/or may also include an upper enclosure or frame 35 at an upper extremity of the pillars 31A, 31B and extending between the pillars 31A, 31B. The lower enclosure or frame 33 may define a base or at least a portion of a base of the structure 3 and the aerosol generating device heating element 1.

The lower enclosure or frame 33 and the upper enclosure or frame 35 may comprise or consist of a metal, for example, aluminum, copper or steel; or a ceramic; or a plastic, for example, a high temperature resistant plastic.

The pillars 31A, 31B and the first and second heaters 37, 39 define or delimit the chamber 5, or the pillars 31A, 31B, the first and second heaters 37, 39 and the lower enclosure 33 and/or upper enclosure or frame 35 define or delimit the chamber 5. The heaters 37, 39 of the chamber 5 are configured to receive a vaporizable material. Alternatively or additionally, the chamber 5 defines an internal receiving zone RZ configured to receive and hold the consumable containing or already holding a vaporizable material.

The chamber 5 is configured to directly or indirectly receive the vaporizable material, and/or configured to directly or indirectly receive the consumable containing or already holding a vaporizable material.

The pillars 31A, 31B and the first and second heaters 37, 39 may define a chamber 5 having a profile or shape (substantially) complementary to a profile or shape of that of the consumable CR, as for example shown schematically in FIGS. 11A and 11B.

The heater 37, 39 comprises or consists of, for example, at least one elongated member or structure 118 (see, for example, FIGS. 7A and 17A), an upper opening 121 and a lower opening 123. The at least one elongated member or structure 118 defines, for example, an enclosure 119 (FIG. 7B), and the upper opening 221 and the lower opening 223.

The enclosure 119 is configured to receive and hold therein at least a portion of the consumable CR containing or holding the vaporizable material. The at least one elongated member or structure 118 of the heater 37,39 is, for example, configured to be in contact (directly or indirectly) with at least a portion of the consumable CR when the consumable is positioned in the heating element 1.

The heater 37, 39 comprises or consists of, for example, at least one elongated member or structure 118 or a plurality of elongated members or structures 118 (see for example FIGS. 17A to 17D). The elongated member or structure 118 may include a first longitudinal extremity 124A and a second longitudinal extremity 124B, and extends longitudinally or lengthwise between these first and second extremities 124A, 124B. The at least one elongated member or structure 118 extends longitudinally to define, for example, a band or a belt. The elongated member or structure 118 may also include an upper perimeter 125A and a lower perimeter 125B, and extends between the upper and lower perimeters 125A, 125B.

The longitudinal extremities 124A, 124B may be attached to the attachments mechanism 111 previously mentioned.

The first and second extremities 124A, 124B may be directly or indirectly in contact or may not be in contact. For example, FIG. 17B shows a single elongated member or structure 118 where the first and second extremities 124A, 124B are indirectly in contact via the attachment mechanism 111. FIG. 17C shows. For example, a plurality of elongated members or structures 118 whose extremities 124A, 124B are also indirectly in contact with each other via the attachment mechanisms 111. FIG. 17D shows, for example, a plurality of elongated members or structures 118 where first and second extremities 124A, 124B are indirectly in contact via the elements of the structure 3, for example, via supports 31 and the lower frame 33 and/or the upper frame 35 (not shown).

The at least one elongated member or structure 118 is, for example, flexible and configured to be contoured, bent or shaped to define a desired profile or shape.

In the exemplary non-limiting embodiment of FIGS. 7A and 7B, the elongated member or structure 118 of each of the first and second heaters 37, 39 have a (substantially) circular cross-sectional profile. The elongated member or structure 118 extends downwards between the upper and lower perimeters 125A, 125B to converge inwardly in a direction extending towards a center C of the aerosol generating device element or heating element 1. The elongated member or structure 118 thus comprises or defines at least a sloped inner wall or surface.

In the non-limiting example shown in FIG. 7, the elongated member or structure 118 of each of the heaters 37, 39 delimits a conical shape. The supports 31 when extending downwards converge inwardly in the direction extending towards a center C of the aerosol generating device element or heating element 1 and together with the elongated members or structures 118 delimits a conical shape or truncated conical profile.

The lower frame 33 and/or the upper frame 35 may be included and, for example, may delimit an annular form as shown in the exemplary embodiment of FIG. 7B. The lower frame 33 defines a smaller circumferential length, width or diameter than that of the upper frame 35.

While described in relation to FIGS. 7A and 7B, the above description of the elements of the structure 3 equally applies to other embodiments of the present disclosure in which the structure 3 is included.

The heaters or braided conductor heating elements 37,39 define walls of the chamber 5. The walls and more particularly an inner surface of each wall defines an enclosure configured to receive the consumable CR. FIG. 11B shows the consumable CR in contact with the inner surface of the walls and held in the chamber 5. The first heater or braided conductor heating element 37 extends to define a wall or at least a portion of at least one wall of the chamber 5. The second heater or braided conductor heating element 39 extends to define a further wall or at least a portion of at least one further wall of the chamber 5.

Each of the first and second heaters or braided conductor heating elements 37, 39 may extend circumferentially or peripherally on the chamber 5 to each define at least one wall or define wall portions of the chamber 5.

The structure 3 comprises the first or upper extremity 19 and the second or lower extremity 15 (see for example, FIG. 7A), and the first heater or braided conductor heating element 37 is, for example, located between the first and second extremities 19, 15. The first heater or braided conductor heating element 37 is, for example, located between the second heater or braided conductor heating element 39 and the second or lower extremity 15. The first and second heaters or braided conductor heating elements 37,39 are spaced apart.

The second heater or braided conductor heating element 39 may, for example, be configured to provide a different heating temperature to that of the first heater or braided conductor heating element 37. For example, the second heater or braided conductor heating element 39 may provide a lower or a higher heating temperature than the first heater or braided conductor heating element 37.

For example, the first heater or braided conductor heating element 37 is shorter in length or peripheral/circumferential length (as for example shown in FIG. 7B) relative to the second heater or braided conductor heating element 39 to provide a lower heating temperature than the second heater or braided conductor heating element 39, assuming that the same strand material is used in both the first and second heaters or braided conductor heating elements 37,39 or that the first and second heaters or braided conductor heating elements 37,39 have the same material resistivity.

Alternatively, for example, the first heater or braided conductor heating element 37 has a resistance value or resistivity value that compensates for a shorter length or peripheral/circumferential length relative to the second heater or braided conductor heating element 39 to provide a higher heating temperature than the second braided conductor heating element 39.

The inclusion of a plurality of heaters or braided conductor heating elements 37, 39 permits the aerosol generating device element 1 to provide different heating temperatures at different locations between the upper and lower extremities 15, 19 and provide a heating temperature gradient.

The vaporizable material can thus be vaporized at different temperatures as vaporizable material extends along the fluidic communication path FCP.

As previously mentioned, the vaporizer element or heating element 1 may include the at least one wick structure 7 or a plurality of wick structures 7A, 7B (see, for example, FIGS. 8, 9, 10A and 10B), as described above.

The wick structure 7 is configured to receive and (temporarily) hold a vaporizable material. The wick structure 7 is, for example, configured to displace a vaporizable material through the wick structure 7 by capillary action or by a capillary force. The wick structure 7 is configured to generate a capillary pressure to transport or displace the vaporizable material.

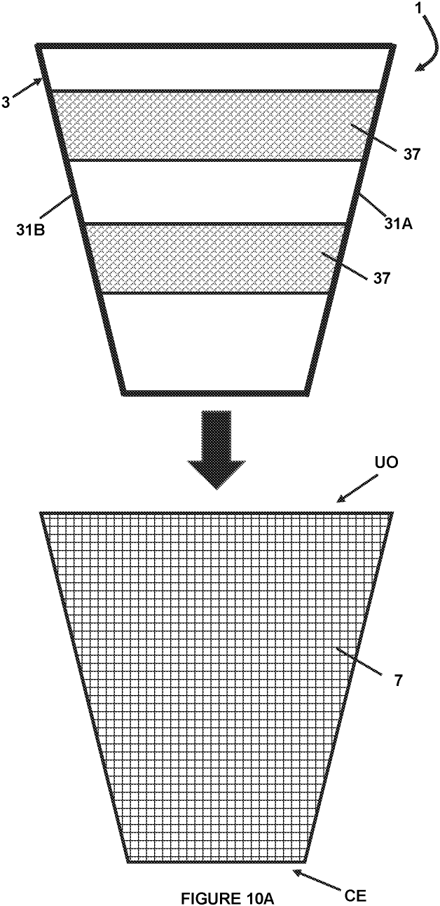

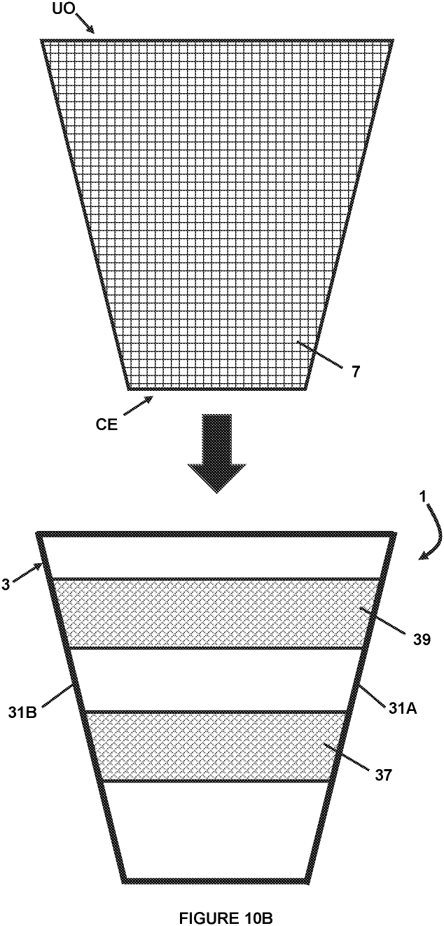

Similar to the embodiment of FIG. 4, the wick structure 7 may, for example, be configured to receive the structure 3 inside the wick structure 7 in an enclosure defined by the wick structure 7, as for example, shown in FIG. 10A. The structure 3 can be attached to the wick structure 7, for example, by a form-fit or press-fit. The wick structure 7 may, for example, have a complementary or corresponding shape to the structure 3 permitting to snuggly receive the structure 3. One or more attachment mechanisms, such as clips or clamps, may also be included, for example, to attach a portion of the structure 3 to at least one wall of the wick structure 7. The wick structure 7 may, for example, define a conical structure as shown in the exemplary embodiment of FIGS. 10A and 10B.

Alternatively or additionally, similar to the embodiment of FIG. 3, the structure 3 may for example be configured to receive the wick structure 7 inside the structure 3, in the enclosure defined by the structure 3, as for example, shown in FIG. 10B. The wick structure 7 can be attached to the structure 3, for example, by a form-fit or press-fit. The wick structure 7 may, for example, have a complementary or corresponding shape (for example, conical) to the structure 3 permitting to snuggly receive the wick structure 7. One or more attachment mechanisms, such as clips or clamps, may also be included, for example, to attach a portion of at least one wall of the wick structure 7 to the structure 3.

The wick structure 7 may, for example, include an upper extremity defining an upper opening UO and a lower extremity CE partially or fully closed by the wick structure 7 to define a vaporizable material receiving surface or area (see, for example, FIGS. 10A and 10B). The wick structure 7 defines, for example, an enclosure configured to receive and hold therein at least a portion of the consumable CR.

The wick structure 7 may, for example, delimit (partially or fully) a conical, squared, rectangular or hexagonal shaped outer or global structure. The wick structure 7 may be truncated. The wick structure 7 may, for example, define a tapered, square, or rectangular circumference or periphery in a plane extending parallel to the insertion direction ID of the capsule CR. The wick structure 7 may, for example, have a circular, oval, square or hexagonal cross-sectional profile in a plane extending perpendicularto the insertion direction ID of the consumable CR.

Alternatively or additionally, the structure 3 may further include at least one wick structure 7 or a plurality of wick structures 7. The wick structure 7 may, for example, extend fully or partially between the first and second heaters 37, 39 (see, for example, FIG. 8). The wick structure 7 may include a lower and upper portion, the lower portion being attached to an upper portion of the first heater 37 and the upper portion being attached to a lower portion of the second heater 39.

The attachments may be assured using attachment mechanisms, such as, stitching or a plurality of annular attachments. For example, a wire/thread may extend or loop through a portion or portions located at the extremities of both the wick structure 7 and the heaters 37, 39 to stitch the wick structure 7 and the heaters 37, 39 together.

In an exemplary embodiment, attachment may, for example, be made using the previously mentioned linking wires or strands when included in the braided conductor heating elements.

Alternatively or additionally, the wick structure 7 may be attached to the supports 31 of the structure 3 in the same manner as that previously described in relation to the heaters 37, 39, that is, using identical attachment mechanisms as those described above.

The wick structure 7 can extend along an inner and outer portion of the structure 3 to define a portion of the chamber 5.

Alternatively or additionally, the wick structure 7A may be located at or delimit partially or fully the upper extremity 19 of the structure 3 or the lower extremity 15 of the structure 3. A first wick structure 7A may be located at or delimit the upper extremity 19 of the structure 3 and a second wick structure 7B may be located at or delimit the lower extremity 15 of the structure 3. The first wick structure 7A may also be attached to the upper heater 39. The second wick structure 7B may also be attached to the lower heater 37.

The second wick structure 7B may alternatively or additionally be attached to the lower frame 33 and/or the first wick structure 7A may alternatively or additionally be attached to the upper frame 35 of the structure 3. The second wick structure 7B may for example, be located inside the lower frame 33. The wick structures may for example, surround or wrap around the lower frame 33 and/or the upper frame 35.

When located at the upper extremity 19, the wick structure 7 includes an upper opening UO. When located at the lower extremity 15, the wick structure 7 may be partially or fully closed at the lower extremity 15 by the wick structure 7 to define a vaporizable material receiving surface or area.

FIG. 9 shows an exemplary embodiment of the present disclosure in which a first wick structure 7A delimits the upper extremity 19 of the structure 3, a second wick structure 7B delimits the lower extremity 15 of the structure 3 and a third wick structure 7C is located between the heaters 37, 39.

The wick structure 7 may extend along or define at least a portion of the base of the structure 3 or the heating element 1. The wick structure 7 may extend to define at least a portion of at least one wall of the structure 3 or chamber 5.

The fluidic communication path FCP may, for example, comprise or pass through/along at least one portion the first heater 37, at least one portion of the second heater 39 and at least a portion of at least one wick structure 7. The portion of the wick structure 7 may, for example be located between the first and second heaters 37, 39. FIG. 8 shows such an exemplary fluidic communication path FCP.

The fluidic communication path FCP may, for example, also include a portion of a wick structure 7 located above or below a heater, for example, located above the upper heater 39 and/or below the lower heater 37, for example, at the lower extremity 15.

The structure 3 may, for example, define a truncated and/or tapered holder 5 as, for example, shown in FIGS. 1A, 2, 3 or 7A.

The at least one wall 11 extends, for example, upwards and laterally outwards to define the opening 17 for receiving the consumable CR. The at least one wall 11 may, for example, extend upwards and laterally outwards to define a truncated and/or tapered chamber for receiving the consumable CR.

The structure 3 or holder 5 may, for example, have a truncated and/or tapered cross-sectional profile in a plane extending from the upper extremity 19 to the lower extremity 15, or extending in the insertion direction ID of the capsule CR (FIG. 1A).

The structure 3 or holder 5 may, for example, delimit (partially or fully) a conical, squared or hexagonal shaped holder 7. The structure 5 or holder 7 may, for example, define a tapered, square, or rectangular cross-sectional circumference or periphery in a plane extending parallel to the insertion or receiving direction ID of the consumable CR.

The structure 3 or holder 5 may, for example, have a circular, oval, square or hexagonal cross-sectional profile in a plane extending perpendicular to the insertion direction ID of the consumable CR. FIG. 26B shows, for example, a circular or oval cross-sectional profile.

The heater/heating means 37, 39 may define or have the same profiles or shapes mentioned above in respect to the structure 3 or holder 5. The lower frame 33 and/or the upper frame 35 may also define or have the same profiles or shapes mentioned above in respect to the structure 3 or holder 5 in a plane extending perpendicular to the insertion direction ID of the consumable CR.

The holder 5 is configured to removably receive the consumable CR or at least a portion of the consumable CR. The holder 5 is, for example, configured to removably receive at least 50%, or at least 75% or at least 95% of the volume delimited by the consumable CR. FIGS. 1A and 11A show, for example, the consumable CR being received in the vaporizer element 1 and FIGS. 1B and 11B show the consumable CR received therein.

The opening 17 defined by the at least one wall 11 of the vaporizer element 1 may, for example, be wider than a width of that the consumable CR. This facilitates lateral evaporation of the vaporizable material or substance.

The consumable CR or the structure 3 may optionally, for example, include a spacer or seal 21 located at a periphery of the consumable CR or the structure 3. The spacer or seal 21 permits the consumable CR to be maintained at a predetermined distance from at least a portion of the structure 3. This facilitates lateral evaporation of the vaporizable material or substance from the structure 3 or wick structure 7.

Alternatively, the relative shapes of the consumable CR and/or the structure 3 may permit the consumable CR to be maintained at a predetermined distance from at least a portion of the structure 3.

The consumable CR may be in direct contact with at least a portion of the wall 11 and the wick structure 7 and/or the first and/or second heating means 37, 39.

The consumable CR is, for example, a heater-less consumable or heating element-less consumable. The consumable CR may have a profile or shape (substantially) complementary to a profile or shape of that of the holder 5 defined by the structure 3 of the vaporizer element 1.

The consumable CR comprises a sealed structure or framework FW configured to hold or holding at least one vaporizable material (see, for example, FIG. 1A).

The structure FW may include, for example a base B, a top section TS and at least one wall WL extending between the base B and the top section TS and defining an enclosure in which the at least one vaporizable material is held.

The structure or framework FW may, for example, comprise of consist of a metal, for example, aluminum, or a metallic alloys of any of aluminum, copper or steel.

The structure or framework FW may, for example, include an inlet (not illustrated) for filling or refilling the consumable CR.

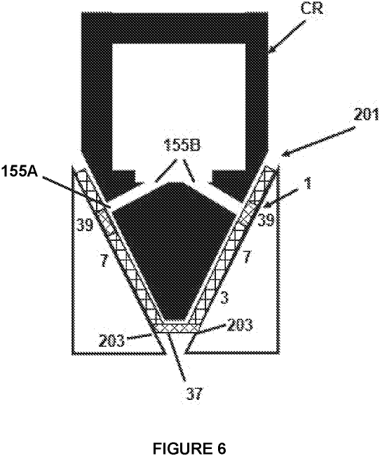

The structure or framework FW may, for example, include at least one or a plurality of orifices 155A (see for example FIGS. 6 and 22B) through which the vaporizable material flows or exits the consumable CR. The structure or framework FWof the consumable CR may, for example, include at least one conduit 155B in fluid communication with at least one orifice 155A.

The at least one orifice 155A can, for example, be located above or directly above the lower heating means 37, when the consumable CR is received in the vaporizer element 1, to release the vaporizable material directly onto the lower heating means 37 and/or the wick structure 7. Alternatively or additionally, an orifice 155A can, for example, be located beside or facing the upper heating means 39 to release the vaporizable material directly onto the wall 11 and upper heating means 39, as for example shown in FIGS. 6 and 22B.

The consumable CR may, for example, also include a valve VL associated with the orifice 155A (see, for example, FIG. 22B). The valve VL is configured to open and release the vaporizable material upon a pressure being applied to the valve VL or being pressed upon, for example, by a pin PN2 located on the structure 3, or in an aerosol generating device or inhalation device including the vaporizable element 1.

The valve VL may, for example, comprise a rubber tube including a normally closed slit. The rubber tube is configured to deform when compressed by the pin PN2 to open the slit to allow the vaporizable material to enter the rubber tube and to exit the orifice 155A.

The at least one or the plurality of orifice 155A may be closed by a membrane that is configured to be ruptured when the consumable is inserted into the vaporizer element 1, as for example shown in FIG. 22A.

The structure FW of the consumable CR may, for example, have a truncated or tapered profile. The consumable CR may, for example, delimit (partially or fully) a conical, squared or hexagonal shaped structure FW. The consumable CR may, for example, define a tapered, square, or rectangular cross-sectional circumference or periphery in a plane extending between the upper and lower extremities of the consumable CR. FIGS. 1A and 11A show, for example, a tapered cross-sectional profile.

The consumable CR may, for example, have a circular, oval, square or hexagonal cross-sectional profile in a plane perpendicular to the plane extending between the upper and lower extremities of the consumable CR.

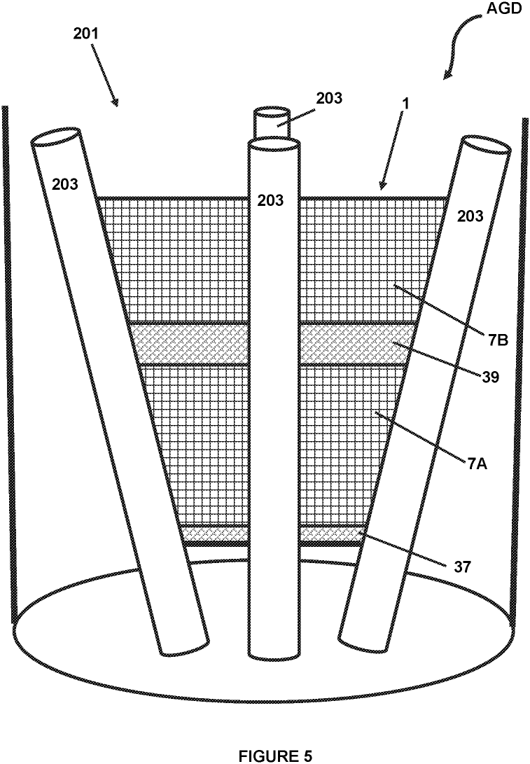

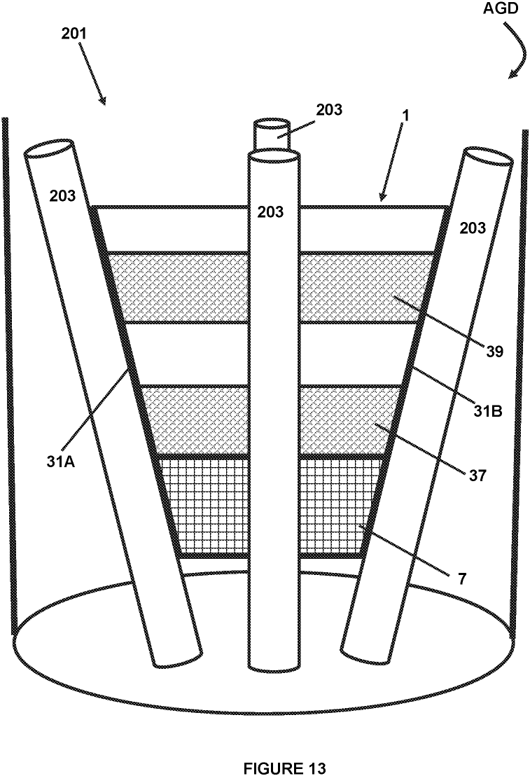

Another aspect of the present disclosure concerns an aerosol generating device or inhalation device AGD including or configured to receive the vaporizer element 1 (see, for example, FIGS. 5 and 13). The aerosol generating device or inhalation device AGD including the vaporizer element 1 is configured to produce an aerosol or vapor for inhalation by a user.

The aerosol generating device AGD includes a cavity or chamber 201 (see, for example, FIGS. 5 or 7) configured to receive the vaporizer element 1 and the consumable CR.

The aerosol generating device may include a plurality of supports or posts 203 for receiving and supporting the vaporizer element 1. The plurality of supports 203 define a reception zone for receiving the vaporizer element 1. The plurality of supports 203 are arranged in the chamber 201 to contact or press against the structure 3.

The plurality of supports 203 may also, for example, define electrical contacts for providing an electrical current to the heating means, for example, to the lower heating means 37 and/or upper heating means 39. This permits an electrical current to be provided to the heating means 37, 39 to generate heat and to vaporize the vaporizable material received by the structure 3 to generate a vapor or aerosol.

The plurality of electrical connectors or contacts 203 are, for example, located in predefined positions in the chamber 201 to directly contact the heating means and define a closed heating circuit when the vaporizer element 1 is positioned inside the aerosol generating device AGD.

The vaporizable material received by the wick structure 7 and/or the heating means 37, 39 from the consumable CR is evaporated to generate the vapor or aerosol.

The aerosol generating device AGD may also include the at least one or the plurality of wick structures 7. The wick structure 7 may, for example, be configured to receive the heating assembly 1 or at least a portion thereof (as, for example, shown schematically in FIG. 13). Alternatively or additionally, the heating element 1 may already include the at least one or the plurality of wick structures 7 when fitted into the aerosol generating device. The wick structure 7 is configured to receive the vaporizable material and the heat generated by the heaters 3 permits the vaporizable material to be evaporated from the wick structure 7 to generate a vapor or aerosol.

As previously mentioned, the vaporizer element 1 is configured to receive and hold the consumable CR. The consumable CR may include or be provided with at least one orifice 155A and/or conduit 155B through which the liquid or vaporizable material flows or exits to provide the liquid to elements of the vaporizer element 1, for example, one or more heaters 37, 39 and/or wick structures 7.

The at least one orifice 155A is located on the consumable CR to release or permit the release of the vaporizable material to the fluidic communication path FCP when the consumable CR is located and received in a predetermined position inside the vaporizable element 1.

The vaporizer element 1 may, for example, further include at least one consumable perforating mechanism 157A (FIG. 22A) or consumable opening mechanism 157B (FIG. 22B) configured to permit the release of the vaporizable material from the consumable CR onto, for example, the wick structure 7 and/or the heating means, for example, the lower heating means 37 and/or the upper heating means 39; or onto the fluidic communication path FCP, for example, onto at least one of the plurality of heaters, for example, upper or second heater 39 and/or the wick structure 7, for example, onto a vaporizable material receiving surface or area.

The at least one or a plurality of consumable perforating mechanisms 157A or consumable opening mechanisms 157B can be included and be located relative to the consumable CR to act on the base B and/or the side wall WL of the consumable CR to permit the vaporizable material to be released from the bottom and/or the side of the consumable CR and be provided to elements of the vaporizer element 1, for example, one or more heating means 37, 39 and/or the wick structure or structures 7.

The consumable perforating mechanism 157A may, for example, comprise a sharp ended pin PN1 (FIG. 22A) that is configured to pierce a portion of the consumable CR or a membrane closing the orifice 155A when positioned in the chamber 201 or in the vaporizer element 1 to gradually or controllably release the contents of the consumable CR.

The consumable perforating mechanism 157A may, for example, comprise a sharp ended pin PN1 extending from the lower extremity of the structure 3 and that is configured to pierce a lower extremity or the base B of the consumable CR to release a portion of the contents of the consumable CR. This consumable perforating mechanism 157A may alternatively be included as part of the aerosol generating device AGD and not the vaporizer element 1. The released contents may, for example, be received by the wick structure 7 and/or the lower heating means 37. Alternatively or additionally, the consumable perforating mechanism 157A may be located on the wall of the structure 3 to pierce the side wall WL of the consumable CR to provide the vaporizable material to the wick structure 7 and/or the upper heating means 39.

For example, the released vaporizable material may directly contact the upper heater 39 and flow to the lower heater 37 via both a capillary force and the gravitational force. The fluidic communication path of the liquid includes portions of the upper and lower heaters 39, 37 and additionally includes a portion of the wick structure 7, in the case where a wick structure 7 is located between the upper and lower heaters.

The consumable opening mechanism 157B may be used instead or in addition to the consumable perforating mechanism 157A and may, for example, comprise an actuator PN2 for activating the valve VL. The actuator PN2 may comprise or consist of a pin PN2 extending from the structure 3 (or from a section of the aerosol generating device AGD) and that is configured to activate/open the valve VL of the consumable CR to release the contents of the consumable CR. The consumable CR may include at least one or a plurality of valves VL located, for example, on the base B and/or the side wall WL of the consumable CR, as shown for example in FIG. 22B.

The vaporizable material received by the wick structure 7 and/or the heating means 37, 39 can be, for example distributed via capillary action along the wick structure 7 and/or along the heating means 37, 39.

The vaporizable material received by the wick structure 7 can be, for example distributed via capillary action along the wick structure 7 and towards a heater, for example, the lower heater 37 when received by the wick structure 7 located at the lower extremity 15 (see, for example, FIG. 13).

In the case where an orifice 155A is located on the base B of the consumable CR and provides the vaporizable material to the wick structure 7 located at the lower extremity 15 of the heating element 1, the capillary action or force of the wick structure 7 can transport or displace the vaporizable material upwards and against gravity towards the lower heater 37 to be evaporated by heat provided by the heater 37. The fluidic communication path FCP of the vaporizable material thus includes a portion of the wick structure 7 and a portion of the lower heater 37.

When the vaporizable material is released from the base B of the consumable CR, the vaporizable material is received by the lower wick structure 7A and/or the lower heating means 37. The vaporizable material is distributed or displaced via capillary action by the lower wick structure 7A (and possibly by the lower heating means 37) upwards along the wall 11 defined by wick structure 7. The vaporizable material is distributed or displaced, for example, upwards between the consumable CR and the structure 3 of the vaporizer element 1. The vaporizable material is distributed or displaced towards the upper heating means 39 in the case where the upper heating means 39 is included in the structure 3.

The vaporizable material received by the wick structure 7 can be, for example distributed via capillary action along the wick structure 7 and towards one or more heaters.

In the case where an orifice 155A is located on the base of the consumable CR, the capillary action or force of the wick structure 7 can transport or displace the liquid upwards and against gravity towards the upper heater 39 to be evaporated also by heat provided by the upper heater 39 as well as the lower heater 37. The fluidic communication path FCP of the liquid thus includes at least a portion of the wick structure 7 and a portion of the lower heater 37, and possibly also the upper heater 39. The lower heater 37 and/or wick structure 7 define a starting location of the fluidic communication path FCP.

The orifice 155A can be, for example, in direct contact with a heater 37, 39 or wick structure 7 when the consumable CR is received in the heating element 1 to define a starting location of the fluidic communication path FCP.

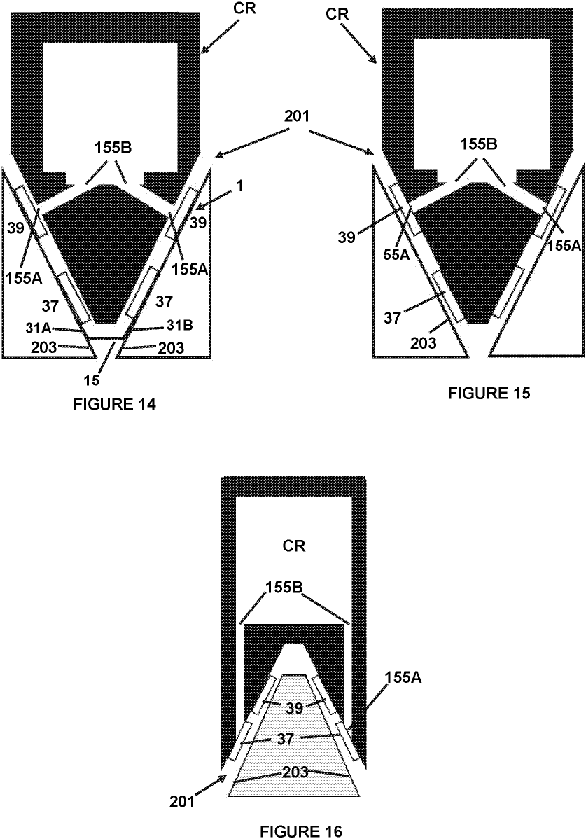

FIGS. 6 and 14 show an example of a consumable CR in which the vaporizable material is provided to the upper heating means 39 via, for example, two conduit 155B and orifices 155A of the consumable CR. The vaporizable material moves to the lower heating means 37 via the action of gravity and in addition by capillary action of the wick structure 7 when provided between the heating means 37, 39 (wick structure 7 is absent in the exemplary embodiment of FIG. 14 that include the heating element 1 in which a wick structure is not necessarily included). The upper heating means 39 may, for example, be configured to provide a lower heating temperature to that of the lower heating means 37. The lower heating means 37 can thus evaporate the substance at a higher temperature.

The vaporizable material may be provided by the consumable CR to only the wall 11 at one or more different locations, or only to a lower extremity of the structure 3, or to both. The vaporizable material flows or is displaced along a fluid communication path FCP that may comprise one or more heating means 37, 39 and one or more wick structures 7 (when present), or only one or a plurality of wick structures 7, or only one heating means. The displacement is assured by capillary force displacement or a combination of capillary force displacement and gravity.

The electrical contacts 203 of the aerosol generating device of AGD are, for example, attached to an energy source, such as a battery, to provide an electrical current to the heating means, or to elements of the induction or electromagnetic radiation heating. As mentioned, the electrical contacts 203 are configured to contact the heaters to define a closed circuit through the heater and through which a current may flow to generate heat.

In the case where the heating means 37, 39 comprises or consists of the braided conductor heating element, the heating temperature of the braided conductor heating element can be defined by a separation distance d₁ between the electrical connectors or contacts 203. A resistance value can be defined by a separation distance d₁ between the electrical connectors or contacts 203. As schematically shown in FIG. 20, the electrical connectors or contacts 203 can contact the braided conductor heating element to define a separation distance d₁ between the electrical connectors or contacts 203 along the total length l₁ of the braided conductor heating element. The resistance value of the section of the braided conductor heating element through which current will flow can be defined by the separation distance d₁ between the electrical connectors or contacts 203. This is equally true in the case where the heating means 37, 39 comprises or consists of the meshed structure.

FIG. 21 schematically shows a possible exemplary configuration for providing an electrical current through portions of the braided conductor heating element or meshed structure via the electrical connectors or contacts 203.

Alternatively, or additionally, the heating means and/or the wick structure may generate heat via induction or electromagnetic radiation heating as previously described above. In such cases, a support or a plurality of supports may be provided instead of the electrical contacts 203, the support or supports being configured to receive and hold the heating element 1.

Another aspect of the present disclosure concerns a consumable system including the vaporizer element 1 and further including the consumable CR containing at least one vaporizable material wherein the consumable CR is a heater-less consumable or heating element-less consumable.

In the consumable system, the opening 17 defined by the wall 11 of the vaporizer element 1 is, for example, wider that of the consumable CR to facilitate lateral evaporation of the vaporizable material. The consumable CR may include the at least one valve VL or membrane closing the orifice 155A, and the consumable perforating mechanism 157A comprises the pin PN1 or consumable opening mechanism 157B comprises the actuator PN2 for respectively activating the membrane or valve VL. The consumable CR may for example delimit, at least partially, a conical, square or hexagonal shape; or defines a conical, square or hexagonal circumference.

Another aspect of the present disclosure concerns an aerosol generating device element that comprises or consists the consumable CR, of which, an exemplary embodiment is shown in FIG. 12.

The consumable CR includes or consists of the heating element 1 as previously described.

The consumable CR includes a plurality of the previously mentioned heaters 37, 39 for example, the first braided conductor heating element 37 and the second braided conductor heating element 39 as well as the structure or framework 3, FW defining a holder or reservoir 5. The holder or reservoir 5 is configured to receive and/or hold at least one vaporizable material inside the holder 5 or inside the consumable CR.

The structure 3 defines, for example, a sealed or a fully closed structure or framework configured to hold the at least one vaporizable material inside the holder 5. The structure 3 may include, for example the base B, the top section TS and the at least one wall WL extending between the base B and the top section TS and defining an enclosure in which the at least one vaporizable material is held.

The structure 3 may define the consumable CR.

The structure or framework 3, FW may, for example, include an inlet (not illustrated) for filling or refilling the holder or reservoir 5.

The structure or framework 3, FW may, for example, include at least one orifice 155A through which the vaporizable material flows or exits the consumable CR. The structure or framework 3, FW may, for example, include at least one conduit 155B in fluid communication with the orifice 155A.

The at least one orifice 155A can, for example, be located beside or facing a heater 37, 39 to release vaporizable material directly onto the heater 37, 39 as for example shown in FIG. 15.

The structure or framework 3, FW includes the first and second heaters 37, 39 and each of the first and second heaters 37, 39 separately extend to each define a portion of the holder 5. The first and second heaters 37, 39 extend, for example, to each define at least a portion of the at least one wall WL of the holder 5.

The heaters 37, 39 may, for example, each define an inner and/or outer portion of the at least one wall WL of the holder 5.

The heaters 37, 39 may, for example, only define an outer surface of the holder 5 or an outer portion of the at least one wall WL of the holder 5. The structure or framework 3, FW may comprise or consist of a sealed sheet defining the holder 5 to which the heaters 37, 39 are attached thereto on an external surface.

The heaters 37, 39 are identical to those described previously in this disclosure.

Each of the heaters 37, 39 may extend circumferentially or peripherally to define the portions of the holder 5 or of the at least one wall WL.

The structure 3 comprises a first or upper extremity 19 and a second or lower extremity 15. The second heater 39 is, for example, located between the first and second extremities 15, 19, and the first heater 37 is, for example, located between the second heater 39 and the second or lower extremity 15.

The fluidic communication path FCP of the consumable CR may, for example, comprise or pass through/along at least one portion the second heater 39, at least one portion of the first heater 37 and at least one portion of the structure or framework 3, as for example, shown in FIG. 12

The fluidic communication path FCP may further include a portion of at least one or a plurality of wick structures 7 when the consumable CR is placed in the heating element 1 and one or a plurality wick structures 7 is provided in the heating element 1.

The at least one orifice 155A of the consumable CR defines the depart of the fluidic communication path FCP and can be located to directly face or be directly located behind a heater 37, 39.

The structure 3 may, for example define a truncated or tapered holder 5. The structure 3 or holder 5 may, for example, delimit (partially or fully) a conical, squared or hexagonal shaped holder 5. The structure 3 or holder 5 may, for example, define a tapered, square, or rectangular cross-sectional circumference or periphery in a plane extending between the upper and lower extremities 19, 15. FIG. 12 shows, for example, a tapered cross-sectional profile.

The structure 3 or holder 5 may, for example, have a circular, oval, square or hexagonal cross-sectional profile in a plane perpendicular to the plane extending between the upper and lower extremities 15, 19.

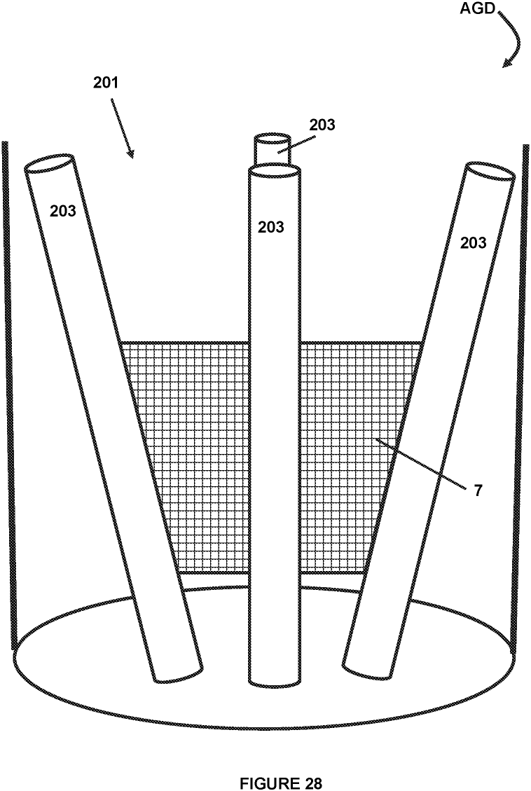

The present disclosure also concerns an aerosol generating device AGD including a chamber 201 for receiving the consumable CR, and a plurality of electrical contacts 203 arranged to contact or press against the first heater 37 and the second heater 39 of the consumable CR to provide current to the first and second heaters 37, 39 for heating the vaporizable material. FIG. 28 shows such an exemplary aerosol generating device AGD, it being noted that the wick structure 7 may be absent or located at a different location so as not to prevent electrical contact should the wick structure 7 not consist of electrical conducting material.

As previously described, the aerosol generating device AGD includes the chamber 201 configured to receive the consumable CR. The plurality of electrical connectors or contacts 203 are arranged to contact or press against the heaters 37, 39 to provide current for heating the vaporizable material. As mentioned previously, in the case where the heating via induction or electromagnetic radiation is used, a support or a plurality of supports are provided instead of the electrical contacts 203, the support or supports being configured to receive and hold the heating assembly or element 1.

The aerosol generating device AGD may include at least one or a plurality of wick structures 7. The wick or mesh structure 7 may define at least a portion of the chamber 201. The wick structure 7 can be, for example, identical to the previously described wick structure 7.

The wick structure 7 can be, for example, positioned in the chamber 201 to receive the vaporizable material that flows or exits the consumable CR when the consumable CR is located in the chamber 201.

The wick structure 7 may, for example, have a complementary shape to the consumable CR and be configured to receive, at least a portion of the consumable CR inside the wick structure 7. The wick structure 7 may, for example, be configured to receive, at least one or the plurality of heaters 37, 39 inside the wick structure 7. The wick structure 7 may, for example, be in direct contact with at least one or the plurality of heaters 37, 39.

The wick structure 7 may, for example, be positioned in the chamber 201 to be located between the heaters 37, 39 of the consumable CR when the consumable is located inside the chamber 201.

The wick structure 7 may, for example, have a profile identical to that of FIG. 4.

The wick structure 7 may, for example, be attached to the supports or the electrical connectors or contacts 203, as for example, schematically shown in FIG. 28.

The aerosol generating device may also include the consumable perforating mechanisms 57A or consumable opening mechanisms 57B to permit the release of the vaporizable material from the consumable CR.

FIG. 15 shows a non-limiting exemplary consumable CR. The vaporizable material exits the orifice 155A and is received by the upper heater 39 and part of the received liquid will be vaporized by the upper heater 39. By the action of gravity, part of the liquid flows to the lower heater 37, directly and/or indirectly via the structure 3, and the liquid is additionally vaporized by the lower heater 37. The fluidic communication path FCP may thus comprise or pass through/along a portion the first heater 39 and a portion of the second heater 37, or a portion the first heater 39, a portion of the second heater 37 and along a portion of the structure 3.

Should a wick structure 7 be also included or located (when included in the aerosol generating device heating element 1) between the heaters 37, 39, by a combined action of gravity and capillary action, part of the liquid flows to the lower heater 37 via, for example, the wick structure 7 (or a portion of the mesh structure 7) located between the heaters 37, 39 and the liquid is additionally vaporized by the lower heater 37.

The lower heater 39 can for example be configured to vaporize the liquid at a higher or lower temperature than that of the upper heater 3A.

FIG. 16 shows another non-limiting exemplary consumable CR. The vaporizable material exits the orifice 155A and is received by the lower heater 37 and part of the received liquid will be vaporized. By capillary action of the heater 37, part of the liquid may flow towards or to the upper heater 39, that, for example, can be in close proximity. Optionally, a wick structure 7 (or a portion of the wick structure 33) of the aerosol generating device heating element 1 may be located between the heaters 37, 39 to transport the vaporizable material to the upper heater 39 and the liquid is additionally vaporized by the upper heater 39. The lower heater 37 can for example be configured to vaporize the liquid at a lower or higher temperature than that of the upper heater 39.

Implementations described herein are not intended to limit the scope of the present disclosure but are just provided to illustrate possible realizations.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments and be given the broadest reasonable interpretation in accordance with the language of the appended claims. The features of any one of the above-described embodiments may be included in any other embodiment described herein.

1. A vaporizer element for an aerosol generating device comprising
a structure defining a chamber configured for removably receiving at least a portion of a consumable therein, the consumablebeing removable from the structure and containing at least one vaporizable material, wherein the structure comprises at least one wick structure for receiving the at least one vaporizable material, the at least one wick structure extending along at least an inner portion of the structure to define at least a portion of the chamber, and
a first heater and a second heater, the at least one wick structure extending fully or partially between the first and second heater, wherein the first and/or second heater comprise a braided conductor heating element or a meshed structure configured to displace the at least one vaporizable material by capillary action.

2. The vaporizer element according to claim 1, wherein the structure comprises a base and/or at least one wall extending to define the chamber, and the at least one wick structure extends along or defines at least a portion of the base and/or at least a portion of the at least one wall.

3. The vaporizer element according to claim 2, wherein the at least one wick structure fully defines the at least one wall and/or the base.

4. The vaporizer element according to claim 2, wherein the at least one wall extends outwards from a first extremity to define an opening at a second extremity for receiving the consumable.

5. The vaporizer element according to claim 4, wherein the at least one wick structure extends along an inner surface of the at least one wall between the opening and the first extremity or between the opening and the base, or defines an inner surface of the at least one wall between the opening and the first extremity or between the opening and the base.

6. The vaporizer element according to claim 1, wherein the at least one wick structure is in thermal contact with the first and/or second heater.

7. The vaporizer element according to claim 1, wherein the first and/or second heater extends along at least an outer portion of the structure or at least an inner portion of the structure to define at least a portion of the chamber.

8. The vaporizer element according to claim 2, wherein the first heater is located in or on the base or defines the base, and the second heater is located in or on the at least one wall or defines at least a portion of the at least one wall.

9. The vaporizer element according to previous claim 1, wherein the at least one wick structure only extends between the first and second heaters.

10. The vaporizer element according to claim 4, wherein the first heater is located at the first extremity, and the second heater is located between the opening and the first extremity, or at the second extremity of the at least one wall defining the opening.

11. (canceled)

12. The vaporizer element according to claim 2, wherein the at least one wall extends upwards and laterally outwards to define a truncated and/or tapered chamber for receiving the consumable.

13. The vaporizer element according to claim 1, further including a consumable perforating mechanism or consumable opening mechanism configured to permit the release of the at least one vaporizable material from the consumable onto the at least one wick structure and/or the at least one heater.

14. The vaporizer element according to claim 1, wherein the structure includes the first and second heater, the first and second heater being separately located on the structure and along at least one fluidic communication path of the at least one vaporizable material, and wherein the first heater is configured to generate a first vaporization heating temperature and the second heater is configured to generate a second vaporization heating temperature different than the first vaporization heating temperature.

15. (canceled)

16. The vaporizer element according to claim 1, wherein each of the first and second heaters extend circumferentially to define portions of the chamber or of the at least one wall.

17. The vaporizer element according to claim 4, wherein the first heater is between the first and second extremities, and the second heater is located between the first heater and the second extremity.

18. The vaporizer element according to claim 1, wherein the first and second heaters -define an intertwined or interlaced network for receiving the at least one vaporizable material.

19. The vaporizer element according to claim 1, wherein the first heater and/or the second heater includes braided wire and a flexible substrate or blade to which the braided wire is attached, or includes braided wire and at least one clamp to which the braided wire is attached.

20. (canceled)

21. The vaporizer element according to claim 1, wherein the structure delimits, at least partially, a conical, square or hexagonal shaped holder; or defines a conical, square or hexagonal circumference.

22. (canceled)

23. The vaporizer element according to claim 4, wherein the at least one wick structure is located at or delimits the first extremity and/or the second extremity.

24. (canceled)

25. An Aaerosol generating device according to claim 1, wherein the aerosol generating device includes a cavity receiving the vaporizer element, and a plurality of electrical contacts arranged to contact or press against the first heater and/or the second heater permitting to provide current to the first and second heaters for heating the vaporizable material.
